(19) United States
(12) Patent Application Publication
(10) Pub. No.: US 2007/0067322 A1
(43) Pub. Date: Mar. 22, 2007

(54) Political system, method and device

(76) Inventor: Shelton E. Harrison JR., Culver City, CA (US)

Correspondence Address: SHELTON E. HARRISON, JR., 6225 CANTERBURY DRIVE., UNIT 105, CULVER CITY, CA, 90230, US

(21) Appl. No.: 11/371,059

(22) Filed: Mar. 8, 2006

Related U.S. Application Data
(60) Provisional application No. 60/755,930, filed on Jan. 3, 2006.
(60) Provisional application No. 60/712,215, filed on Aug. 29, 2005.

(51) Int. Cl. G06F 7/00

(52) U.S. Cl. 707/100

(57) ABSTRACT

A Universal Political Platform System (UPPS) enables citizens to create and maintain a political party's platform. In a preferred embodiment, a citizen submits a “plank” —a principle, policy, or stance on an issue—via a disclosed electronic form. Other citizens then “ratify” or “oppose” the plank. When party members' ratifications or oppositions of the plank meet predetermined thresholds, the plank becomes “adopted” into the platform. Citizens may donate funds earmarked for promoting a plank. Candidates are evaluated mathematically according to how well they represent party views. User coalitions may also be formed. Licensing information is available at www.inventerprise.com.

### CROSS-REFERENCE TO RELATED APPLICATIONS

Priority filing of U.S. provisional patent application 60/755930, filing date Jan. 3, 2006, entitled “Sequential Representation System, Method and Device,” and of U.S. provisional patent application 60/712215, filing date Aug. 29, 2005, entitled “Universal Electronic Transaction System Improvements,” is claimed. Both of said two provisional patent applications are hereby incorporated by reference in their entirety into the present disclosure.

A portion of the disclosure of this patent document contains material which is subject to copyright protection. The copyright owner has no objection to the facsimile reproduction by anyone of the patent documents or patent disclosure, as it appears in the patent and trademark office patent file or records, but otherwise reserves all rights whatsoever.

The inventor wishes to thank Golnar Zahedin, Scott Colby Hollifield, and Nicole Theiss.

### STATEMENT REGARDING FEDERALLY SPONSORED RESEARCH AND DEVELOPMENT

None.

### REFERENCE TO SEQUENCE LISTING, A TABLE OR A COMPUTER PROGRAM LISTING APPENDIX

None

### BACKGROUND OF THE INVENTION

1. Field of the Invention

The invention relates to political and governmental systems, citizenship, election, legislation, political parties, and law.

2. Description of related art

Under the related art, citizenship is established in one of three ways: jus soli (by place of birth), jus sanguinis (by blood, parentage), and naturalization. These methods are not ideal in that they do not comport with the nature of modern civilization. In an age of multinational corporations and international interdependence, factors such as geography, racial or ethnic background, and current physical residency have little of the significance formerly ascribed to these traditional grounds for citizenship. Linguistic, cultural and socioeconomic fluidity are the norm today, and the trend toward fluidity is accelerating each year, especially through the global influence of the Internet and World Wide Web.

Supranational citizenship attaches to traditional citizenship in a nation that is part of a group of nations that recognizes a particular form of supranational citizenship; for instance, citizenship in a European Union country automatically bestows E.U. citizenship also. Supranational citizenship is a step in the right direction, in that it recognizes that traditional national boundaries have become much more permeable and that the notion of geography-based nationality is at best antiquated and oftentimes counterproductive. However, supranational citizenship does nothing to address the fundamental problems associated with establishing national citizenship in the first place.

What is needed, therefore, is a system and method for establishing citizenship that is more suited for modern society.

Leaving logistical problems aside, however, a more fundamental problem exists under the related art methods of establishing citizenship with respect to the legitimacy of a governing authority. In particular, modern political theorists generally hold that a government is legitimate only if, and only to the degree that, it is established through the will of the people to be governed. However, under jus soli and jus sanguinis methodology, a person becomes a citizen of a given sovereign state to which he or she has never consented. In short, the generally accepted grounds for governmental legitimacy—namely, the will of the governed—is absent.

What is needed, therefore, is a citizenship system that results in legitimate governments.

Once legitimacy has been established, the people of a nation must decide on a system of government. Democracy is considered by many modern theorists to be the best choice. As used in the related art, democracy operates by popular election or vote at some level, and may include voting by representatives rather than all citizens at other levels. “Democracy” —literally, government by the people—is, however, a misnomer as applied in the related art, because, whether by popular vote or through representative vote, the majority of the people—as opposed to all people —makes the rules. Thus, “majocracy” —government by the majority—may be a more accurate term for the governmental systems conventionally grouped under the label “democracy”.

Representative majocracy is, under the related art, divided into two basic forms: winner-take-all and proportional representation (PR), which manifests in various permutations. Winner-take-all systems are criticized for disenfranchising everyone who votes for a losing candidate. Proponents of proportional representation contend that proportional representation systems, by allowing voters in the minority to elect representatives, avoids the disenfranchisement problem of winner-take-all. As can be demonstrated mathematically, however, in terms of actual legislation passed, the results of proportional representation are essentially identical to those of winner-take-all, namely, the majority makes the rules. This legislative outcome occurs for a simple reason: even though minority voters are able to elect representatives, these representatives must nonetheless pass legislation by majority vote. This intervening majocratic event nullifies the cosmetic appearance of successful participation by voters in the minority view. In short, proportional representation is a symbolic nod to minorities; it does not empower minorities to actually enact legislation.

Such symbolism may be important and inspiring, and the illusion of having a voice in government may actually motivate minority voters to participate in the electoral process. But neither form of majocracy is ideal because, unfortunately, majorities are not always right. As the history of slavery and other immoral institutions reflects, the commonness of a given viewpoint does not ensure its credibility.

What is needed, therefore, is a means of achieving a more complete form of democracy.

Once legitimacy and democracy have been established, elections and votes must be held and legislation passed. Under the related art, elections are essentially popularity contests. In a recent election, for instance, a governor of a major state was elected essentially entirely on his status as a media star, since the candidate had no prior political background, no apparent qualifications, and no ascertainable position on relevant issues. While such electoral outcomes serve the highly desirable end of demonstrating that literally “anyone can be governor” and are in this way good motivators for participation in the political process, they also call into question the viability of popular election as a vehicle for selecting qualified political officeholders. Popularity is not necessarily strongly correlated with the skills necessary for effectiveness in office, such as intellectual skills, communication skills, and time- and organization-management skills. It also reveals nothing about whether a candidate, once in office, will actually show up to work; unfortunately, in recent years, absentee politicians have become commonplace. Meanwhile, media-driven popularity does not appear to be correlated at all with positions on political issues, since popular people can be found holding highly varied views.

What is needed, therefore, is a means of indicating to the voting public (i) the aptitude of a given political candidate for office and (ii) the degree to which a given candidate actually represents the substantive views of the party whom he or she claims to represent.

Once a legitimate representative democracy has been established and legislation enacted through representatives of an informed electorate, the laws so enacted must be enforced. Under the related art, a citizen being arrested for possible violation of a law has essentially no way to verify in real-time whether or not an arrest warrant is valid nor even whether the arresting police officer is actually a police officer or is acting within the scope of his or her authority. This uncertainty has a dramatically negative impact on the willingness of a person being arrested to cooperate, especially in jurisdictions where criminals impersonating police officers are common or where prisoner abuse is frequent.

Additionally, under the related art, ignorantia juris non excusat—ignorance of the law is no excuse. While this method of imposing criminal liability conserves executive and judicial resources by eliminating an intuitively reasonable and potentially complete defense, this approach presents a major legitimacy problem. Specifically, few people are capable of gaining actual knowledge of the entire code of laws of a given modern state or nation, and in the absence of such knowledge, the “culpability” of crimes that are not malum in se essentially reduces to “criminal failure to read, research and understand the statutes of this jurisdiction.” Imposition of fines or imprisonment upon an individual for having inadequate legal research ability or interest level seems morally dubious at best, and in the case of defendants who are illiterate, uneducated, and impoverished, such punishment seems downright immoral and unjust. As technology continues to transform society, the number of crimes that are not reasonably characterized as malum in se—downloading a song, for instance, in a manner that turns out to be a copyright violation—will continue to expand dramatically, making the present problem worse.

What is needed, therefore, is a method of enforcing the law that assures citizens that (i) arresting officers are acting within the scope of legitimate authority and (ii) imposition of a penalty has some basis in culpability.

While a state certainly has an interest in enforcing its laws through legitimate means, it is equally certain that a state has an interest in making sure that its citizens—the people who created the state in the first place—are not falsely imprisoned. False imprisonment is, of course, a long-recognized tort and, if it were committed by a foreign nation against a nation's citizens, would be considered an act of war. Clearly, a state has an interest in protecting its own citizens from torts or acts of war.

If a citizen is arrested and prosecuted, he or she must mount a defense, either with privately hired defense counsel or with a public defender (leaving aside self-representation). While numerous scholars have applauded the adversary system of trial as embodying our highest ideals of individual autonomy, this applause has little basis in fact. It is common knowledge among the legal community that the resources available to the public defense bar are minuscule compared to those available to the prosecution, certainly at the state level but even more so at the federal level. Meanwhile, a privately hired defense “dream team” is financially unavailable to all but the most wealthy defendants yet provides a much higher probability of acquittal. In short, under the related art, it is hardly an exaggeration to say that wealth has more exculpatory power than innocence.

What is needed, therefore, if an adversary system of trial is to be used at the criminal level, is a mechanism through which such system of justice can serve to test the innocence rather than the wealth of a defendant.

Under the related art, once a decision has been reached in a trial in a common law system, whether civil or criminal, a judicial opinion explaining the decision is authored by a member of the court and published for future reference. Unfortunately, the quality, length and even relevance of such opinions vary greatly, and such variation serves to inflict a direct harm upon the society on whose behalf the opinion writer supposedly speaks: (i) poorly written judicial opinions leave the law unclear, so that citizens must live in fear; and (ii) poorly written judicial opinions perpetuate and increase the public's reliance upon specialists, i.e., lawyers, since the meaning of an opinion cannot be readily gained from reading it.

What is needed, therefore, is a system that requires judicial opinions to be competently and understandably written.

Even, however, if the laws of a jurisdiction are clear, justice cannot abound if the citizenry cannot readily access these laws and the various applications of these laws. Under the related art, only highly trained specialists, i.e., lawyers, or highly precocious laypersons can begin to handle the morass of legal research. Many if not most people cannot afford the services of such specialists except in a few major crises.

What is needed, therefore, is a system that provides universal, free, direct, simple, uniform and convenient access to all manner of documents that have legal significance in a given jurisdiction.

### BRIEF SUMMARY OF THE INVENTION

A disclosed system, called jus voli (citizenship by volition), allows a nation to become a party to an international agreement whereby each party nation is among a menu of nations from which a person who has attained a predetermined age can choose a citizenship. Upon agreement to be subject to the laws of the chosen nation and payment of any initiation fee, the person thereby becomes a citizen of the chosen nation.

A disclosed system, called sequential representation, allows a plurality of political candidates to share a temporally divided term of office in accordance with the percentage of votes received by each candidate. Representatives elected through this process in turn vote so as to enact legislation.

A disclosed system, called a Universal Political Platform System (UPPS), allows Internet users to register their affiliation with a particular political party, build that party's political platform from the grassroots up through submission of suggested planks for that party's political platform, to ratify and fund such planks, and to compare a given political candidate to the party platform so that a given candidate's actual level of representativeness of the party's views can be quantified. A Political Candidate Aptitude Test (PCAT) system is also disclosed so that voters can be given an objective measure of the qualifications of a given candidate for a given office.

A disclosed system, called a Suspect-Verifiable Warrant, allows individuals who are being arrested to verify the existence of a valid search warrant in real-time—at the time of arrest—using simply a telephone. A disclosed system, called a Citizen Legal Capacity system, puts the burden on the government to inform citizens about criminal behavior that is not malum in se prior to being able to impose criminal liability on citizens for such behavior. An additional disclosed system serves to allocate state funds for the defense of a citizen accused of a crime such that a trial in an adversary system is meaningfully competitive.

A disclosed system, called a Uniform Judicial Opinion (UJO) system, allows and requires judicial opinions to be written in a form that is a rigorous enough to be worthy of being treated as law, which opinions can then be disseminated through a disclosed Legal Markup Language (LML) system.

A disclosed system, called a Universal Legal Document (ULD) system, permits all manner of legally operative documents to be accessed by anyone anywhere through the use of a unique serial number, a ULDN.

### BRIEF DESCRIPTION OF THE DRAWINGS

FIG. 1 is a flowchart disclosing the steps of the current invention in general terms.

FIG. 2A depicts an excerpt from a disclosed web page containing a Web submission form whereby a citizen can choose a national citizenship according to the present invention.

FIG. 2B is a flowchart depicting the steps of a disclosed process called a jus voli process.

FIG. 3 is a flowchart depicting the steps of a disclosed process called a sequential representation process.

FIG. 4 is a flowchart depicting the steps of a disclosed process for limiting term fragmentation in a sequential representation system.

FIG. 5 is a flowchart depicting the steps of another disclosed process for limiting term fragmentation in a sequential representation system.

FIG. 6 is a flowchart depicting the steps of a disclosed process called budgetary representation.

FIG. 7 is a flowchart depicting the steps of a disclosed process whereby a disclosed universal political platform system is created and used.

FIG. 8 is a flowchart depicting the steps of a disclosed process whereby a plank of a political platform is ratified by a user according to the present invention.

FIG. 9 is a flowchart depicting the steps of a disclosed process whereby a plank is opposed by a user according to the present invention.

FIG. 10 is a flowchart depicting the steps of a disclosed process whereby a modification to a plank is proposed by a user according to the present invention.

FIG. 11 is a flowchart depicting the steps of a disclosed process whereby a new plank is proposed by a user according to the present invention.

FIG. 12 is a flowchart depicting the steps of a disclosed process whereby an argument pertaining to a particular plank is submitted by a user of the present invention.

FIG. 13 is a flowchart depicting the steps of a disclosed process whereby a user updates his or her position on a plank.

FIG. 14 is a flowchart depicting the steps of a disclosed process whereby a plank becomes an officially adopted plank in a political party's platform according to the present invention.

FIG. 15 is a flowchart depicting the steps of a disclosed process whereby a candidate is evaluated according to the present invention.

FIG. 16 is a flowchart depicting the steps of a disclosed process whereby a new party is proposed for inclusion in a web site community according to the present invention.

FIG. 17 is a flowchart depicting the steps of a disclosed process whereby a coalition is formed according to the present invention.

FIG. 18 is a flowchart depicting the steps of a disclosed process whereby an alliance of coalitions is formed according to the present invention.

FIG. 19 is a flowchart depicting the steps of a disclosed process whereby funding for a plank can be donated according to the present invention.

FIG. 20 is a flowchart depicting the steps of a disclosed process whereby a political party is held accountable for reporting usage of funds according to the present invention.

FIG. 21 depicts an excerpt from a disclosed web page in which relevant information pertaining to a plank is displayed according to the present invention.

FIG. 22 depicts the web page in FIG. 21 after certain information has changed.

FIG. 23 depicts an excerpt from a disclosed web page through which relevant information pertaining to a candidate is displayed according to the present invention.

FIG. 24 depicts an excerpt from a disclosed web page through which relevant information pertaining to a political party is displayed according to the present invention.

FIG. 25 depicts an excerpt from a disclosed web page through which reports pertaining to a political party's use of donated funds are displayed according to the present invention.

FIG. 26 depicts an excerpt from a disclosed web page including a submission form through which a coalition may be proposed according to the present invention.

FIG. 27 depicts an excerpt from a disclosed web page including a submission form through which a coalition alliance may be proposed according to the present invention.

FIG. 28 depicts an excerpt from a disclosed web page including a submission form through which a leader of a coalition can respond to an alliance proposal according to the present invention.

FIG. 29 depicts an excerpt from a disclosed web page including a submission form through which a new plank can be proposed according to the present invention.

FIG. 30 depicts an excerpt from a disclosed web page including a submission form through which a user of the disclosed invention can register as a candidate according to the present invention.

FIG. 31 depicts an excerpt from a disclosed web page including a submission form through which a user can donate funds according to the present invention.

FIG. 32 is a schematic diagram disclosing major databases and relationships used in a disclosed relational database structure according to the present invention.

FIG. 33 is a schematic diagram of a physical apparatus used in the present invention.

FIG. 34 is a schematic diagram of component systems used in the present invention.

FIG. 35 is a flowchart depicting a disclosed process whereby political candidates are tested according to the present invention.

FIG. 36 is a table depicting a series of relationships between skills and pre-existing tests that can be used in testing candidates according to the present invention.

FIG. 37 is a flowchart depicting the steps of a disclosed process whereby a citizen is informed so as to have legal capacity according to the present invention.

FIG. 38A is a flowchart depicting the steps of a disclosed process whereby a suspect can verify the authenticity of a warrant according to the present invention.

FIG. 38B is a flowchart disclosing a process whereby funds are allocated for defense of an accused in a criminal proceeding.

FIG. 39 depicts an excerpt from a disclosed web page including a submission form through which the author of a judicial opinion can submit a judicial opinion according to the present invention.

FIG. 40A is a flowchart disclosing the steps of a process whereby a judicial opinion is created and published according to the present invention.

FIG. 40B is a chart of disclosed example tags for use in a disclosed legal markup language according to the present invention.

FIG. 41 is a flowchart disclosing the steps of a disclosed universal legal document process according to the present invention.

FIG. 42 is a site flow diagram for a disclosed UPPS site.

### DETAILED DESCRIPTION OF THE INVENTION WITH REFERENCE TO THE DRAWINGS

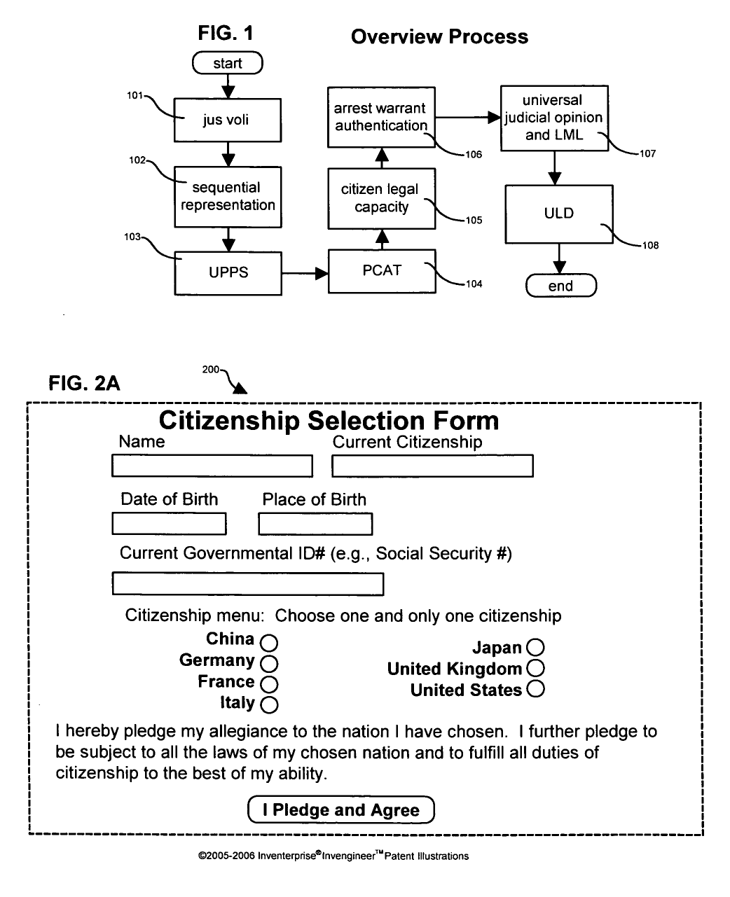

The present invention includes several systems that can be used together or separately. If used together, a likely order for execution of processes disclosed herein appears in FIG. 1, although these processes can be followed in a different order.

Part I: Jus Voli

Under the present invention, a multinational team is created to negotiate 201 the terms of a treaty, and, after such terms are agreeable to all potential party nations, a plurality of nations agrees 202 to the treaty. Thereafter, when a citizen of a party nation meets a treaty-specified age threshold 203, he or she can participate in the remainder of the disclosed process of jus voli citizenship determination; prior to the treaty-specified age, national law governs 204 the individual's citizenship.

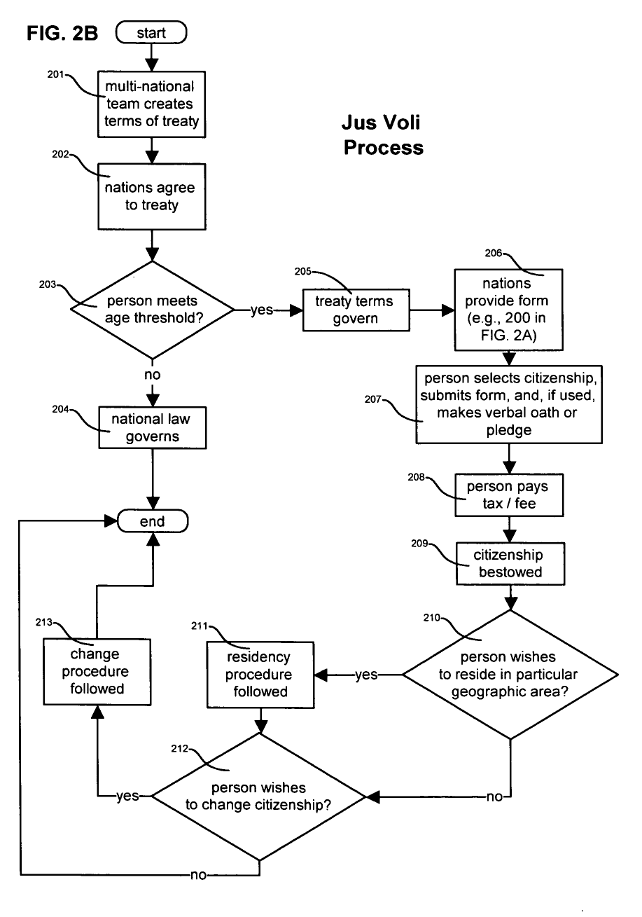

Per the terms of the treaty 205, the qualified citizen is provided 206 a form 200 in FIG. 2A whereby he or she can select 207 a citizenship so as to choose the nation to which he or she will belong. As depicted, this form 200, which can be print or electronic (shown) so as to be globally accessible via the Internet, provides a menu of all signatory nations such that an individual completing the form can choose exactly one nation to join. The form 200 also requires a pledge of allegiance and an agreement to abide by the laws of the chosen nation; it may also be desirable to require a verbal, sworn declaration of the same. Identity of an individual must be verified prior to allowing the individual to submit the form. Thereafter, the citizen pays 208 an initiation fee or tax, which can be set by each individual nation subject to limitations in the treaty, and becomes 209 a citizen of the chosen nation.

Under the present invention, residency is treated separately from citizenship, so as to avoid massive migrations of populations during the early years of jus voli implementation. Thus, if a person wishes 210 to live within the geographical borders of the nation of which he or she has become a new citizen, he or she must follow 211 a residency procedure determined by the individual nation he or she has joined. Such procedure may include a required waiting period of several years, a required tax, an employment requirement, or other measures designed to ensure that the rights and opportunities of prior citizens and residents are not harmed by the grant of citizenship to the new citizen. While such a residency procedure does on its face create “second-class citizens”, this interim measure appears to be a necessary evil that can be justified as a reasonable way to facilitate genuine progress toward the twin goals of personal autonomy and governmental legitimacy while also accommodating practical realities.

While the disclosed system is expressly aimed at empowering the free will of all people and establishing legitimate governments through the exercise of that free will, jus voli is not intended to empower capricious behavior. Thus, if a citizen wishes to change 212 citizenship after having chosen a citizenship through jus voli, he or she must follow 213 a change procedure specified in the treaty. Such procedure may include a limitation on the frequency with which an individual can change citizenship (e.g., a maximum of one change every 10 years) or an absolute numerical limit on the number of citizenship changes an individual can undergo (e.g., three changes per lifetime).

At birth, and until a first jus voli election has been made, the citizenship of an individual is determined per the related art citizenship laws (jus soli, jus sanguinis, naturalization) 204.

Part II: Sequential Representation

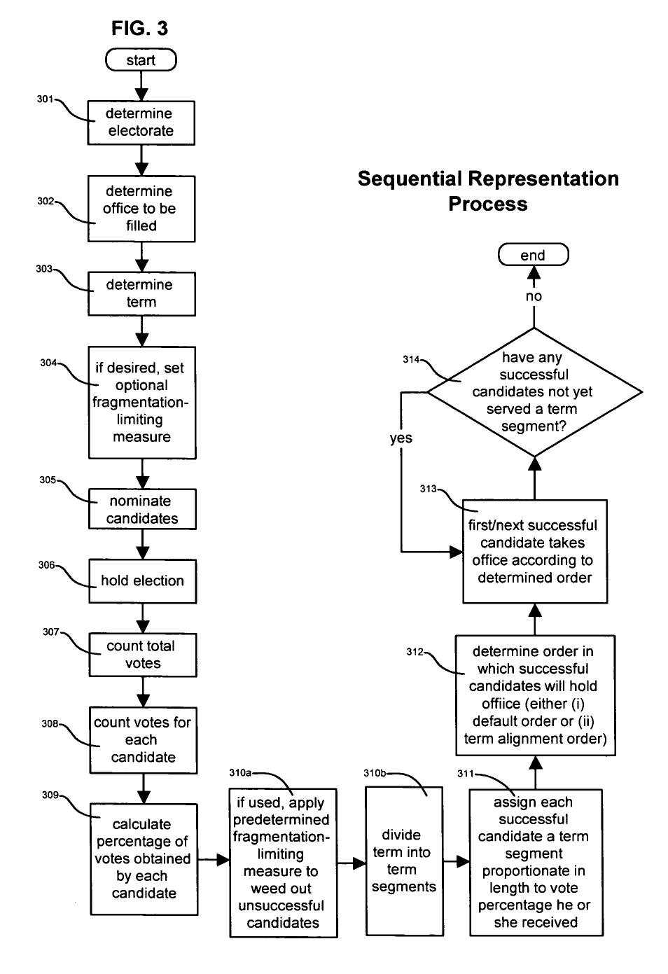

Turning to a process disclosed in FIG. 3, called sequential representation, voting rights are established 301 for an election to be held in which a legislative office, such as that of senator, is to be filled 302 by an elected official for a specified term 303, such as a six-year term. A plurality of candidates are nominated 305 by their respective parties and run 306 for the office, such as a Democratic Party candidate, a Green Party candidate, and a Republican Party candidate. A plurality of voters cast votes 306 in the election, one vote per voter.

After the election, the total number of votes cast is counted 307, as is the individual total for each candidate 308. The percentage of votes received by each candidate is calculated 309.

The specified term is then divided into term segments 310b, each term segment being of a length that is a percentage of the entire term length that equals the percentage of votes received by one of the candidates, and each successful candidate is assigned the term segment that corresponds to his or her percentage of the votes received 311. Each candidate then occupies the office for the duration of the term segment corresponding to that candidate's percentage.

The order in which the successful candidates occupy the seat is determined in one of two alternative ways. In default order, the candidate who received the most votes occupies the office first 313. The candidate who received the second most votes occupies the office second, immediately upon the expiration of the first term segment; the candidate who received the third most votes occupies the office third, immediately upon the expiration of the second term segment, and the process continues accordingly until the entire term has elapsed.

In term alignment order, the results of all elections for the legislature are reviewed, and all successful candidates from the party winning the most elections serve first; then all successful candidates from the party winning the second most elections serve second; and so on. Term alignment order only determines the order, not the length of each term segment; a given successful candidate's term segment length is determined by his or her percentage of the vote as discussed above.

While sequential representation can function regardless of the number of term segments allowed, it is very strongly preferable to limit the number of term segments to two. Such a limit is a reasonable trade-off between the desire to empower minorities to pass legislation and the unfortunate but inevitable necessity of avoiding putting such power into demonstrably destructive minorities, e.g., a Nazi party. If each term is only split between the two major parties, the disenfranchisement problem that occurs under the related art is ameliorated yet the dangers of putting much smaller parties into power are minimized.

If a term is to be divided into three or more segments, then sequential representation should only be used in a bicameral legislative system and only in one house thereof, again as a means of avoiding the risk presented by hate parties.

If only two term segments are used, default order should be used. If more than two term segments are used, the term alignment order-is preferable to offset a phenomenon that occurs in jurisdictions that have two dominant parties and a distant third party: the two dominant parties always win the first and second place term segments but splitting relatively equally between first and second place, whereas the third party dependably always comes in third. In such a scenario, if default order is used, the makeup of the representative body so elected is relatively diluted during the respective periods of control by the first two parties, but this body is very purely composed of only representatives of the third party during the third party's—albeit shorter—period of control of the body.

By contrast, using term alignment order, each party essentially dominates the legislative house for a portion of the entire term, and each period of dominance roughly corresponds in length to the relative voting power of the people represented by a party.

To illustrate sequential representation in action, an example follows:

An election is held for a seat in the senate of a given national government. The term of office associated with this senatorial position is six years. Only three candidates run for the office.

Candidate #1 receives 55% of the total votes cast. Candidate #2 receives 25% of the total votes cast. Candidate #3 receives 20% of the total votes cast.

Using default order, Candidate #1 occupies the office first, immediately at the beginning of the six-year term. He or she holds this office for exactly 3.3 years, which length of time represents 55% of the total six-year term. Candidate #2 occupies the office immediately after candidate #1 leaves the office and holds the office for exactly 1.5 years, which duration represents 25% of the total six-year term. Candidate #3 occupies the office immediately after candidate #2 leaves the office and holds the office for the remainder of the six-year term, namely, 1.2 years, which time span corresponds to his or her 20% of the total number of votes, being 20% of the total six-year term.

Results: the minority voters represented by candidates #2 and 3, which voters would have no legislative power under a winner-take-all or a proportional representation system (assuming that all other legislator elections had similar results and majority vote by legislators is how legislation gets passed), are actually empowered to pass legislation for a portion of the six-year term.

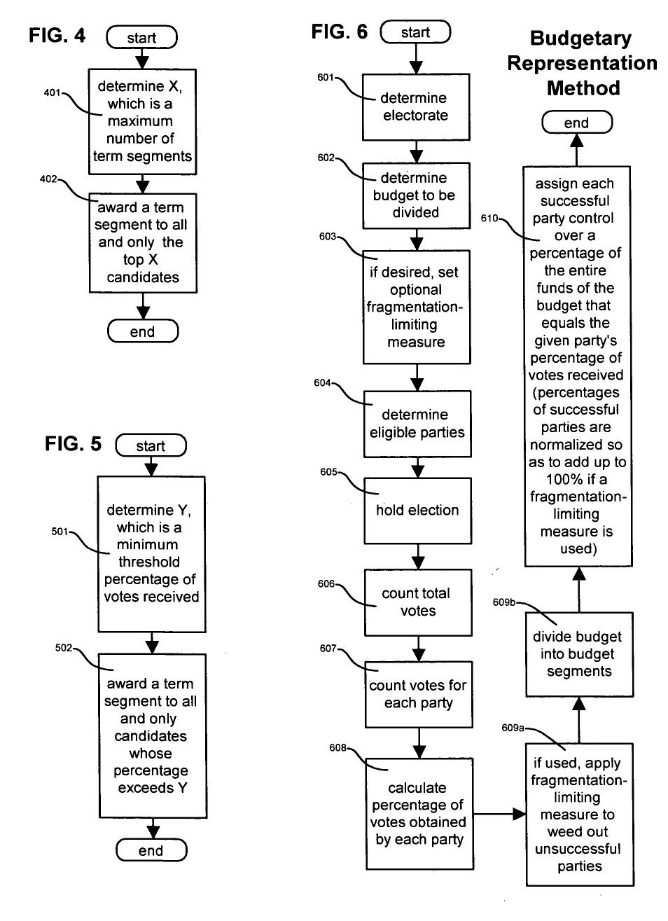

Optional steps may be included to prevent excessive fragmentation of a term. For instance, it is probably not desirable to have a candidate who came in 27th place in an election actually hold the office for a term segment of one or two days, but such a result is possible under “pure” sequential representation. Thus, a term-fragmentation-limiting measure can be established in advance of an election 304. Such a measure can take the form of establishing 401 in FIG. 4 a maximum number of term segments and then allowing only that same number of candidates to serve in office 402. Alternately, such a measure can take the form of establishing 501 in FIG. 5 a minimum percentage of the vote that a candidate must receive in order to be successful and then only allowing such successful candidates to serve in office 502.

For instance, using the latter measure, all candidates receiving less than 10% of the total number of votes cast would not be allowed to occupy the office at all, and votes cast for such excluded candidates would effectively be excluded from the total votes count used to determine the percentages of candidates who successfully met or exceeded the threshold 310a.

In an example of the former measure, an absolute limit on the number of partitions of a given term can be set, such that the entire term is divided between only the top two vote-getters or, alternately, the top three vote-getters, proportionately according to the votes received by only those candidates 310a.

While these measures do effectively disenfranchise a certain number of voters, far fewer voters are disenfranchised under sequential representation than under the related art.

An alternative method of putting actual power in the hands of minorities is disclosed in FIG. 6. Through the depicted process, control over the budget of a given government for a given period of time is divided into budget segments 609b that are proportionate in amount to the percentage of votes received by a given party out of the total votes cast. Control over each budget segment is then assigned 610 to individual parties so that each party has control over that percentage of the budget that equals the percentage of votes received by that party. For example, a political party receiving 33% of the vote is thereby awarded control over 33% of the budget. In this method, it is literally the case that “every vote counts.” Alternate fragmentation-limiting procedures similar to those used in sequential representation (minimum percentage for successful parties, maximum number of budget segments) can and should also be used 603, 609a.

Part III: Universal Political Platform System (UPPS)

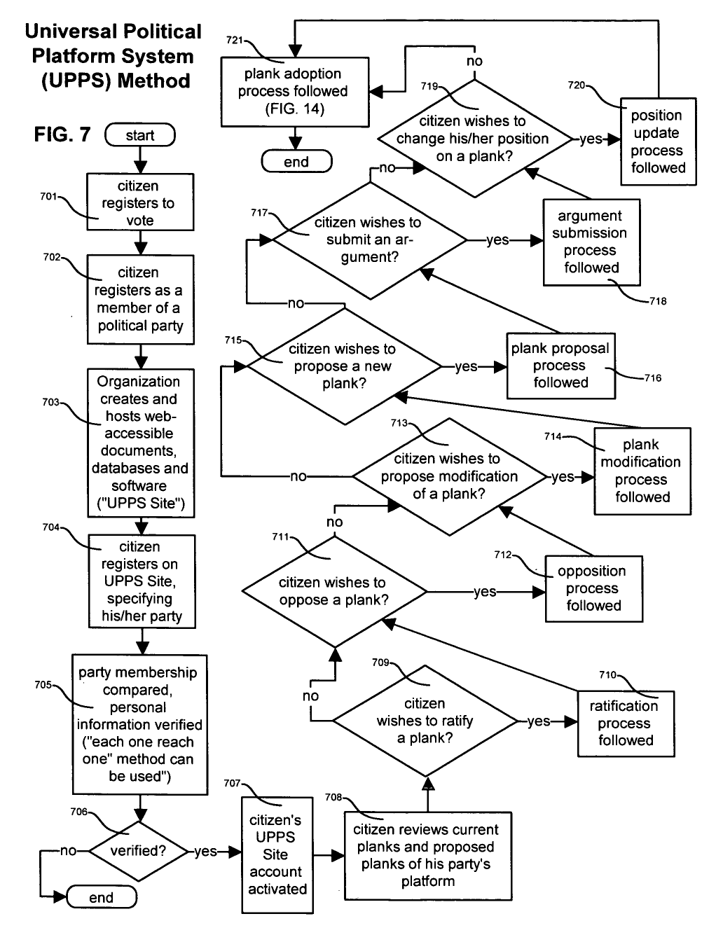

Disclosed in FIG. 7 are the steps of a Universal Political Platform System (UPPS) method. The UPPS system provides an unprecedented opportunity for citizens to participate in formation and adoption of a political party's platform, allowing democratic decision-making to occur not only in elections themselves but also in the creation and maintenance of every “plank” in a party's platform.

The basic UPPS process is as follows. A citizen registers 701 to vote and then registers 702 as a member of a political party. A nonpartisan entity (“Organization”) creates and hosts a database-driven World Wide Web site 703 (“UPPS Site”) that is accessible through the Internet; the UPPS Site includes documents, such as web pages and submission forms (e.g., HTML, XML), as well as databases and software suitable for serving information in response to HTTP requests and for manipulating information in these databases (e.g., PHP, Apache, mySQL).

The citizen then registers 704 on the UPPS Site, specifying the political party of which he or she is a registered member. The citizen's personal information (name, address, etc.) may then be compared 705 to registered voter and registered party member lists to verify that the citizen really is a registered voter and a member of the party he or she claims. If so 706, the citizen's account on the UPPS Site is activated 707. Additionally, electronic or manual security procedures can be enacted so as to detect and prevent attempts by individuals to register more than one account or to belong to more than one political party.

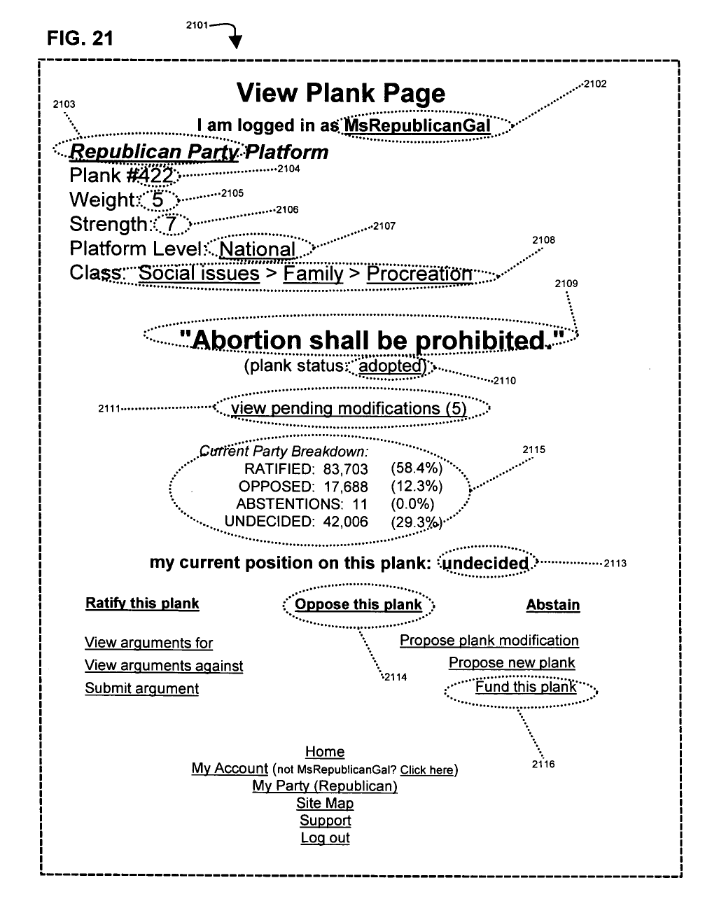

The citizen can then examine 708 the various “planks” —principles, policies, and stances on issues—that have been suggested by other party members for adoption as official planks of the party's platform. A plank may be, for example, that drilling in national forest should be prohibited or that a war should cease. Such a plank is presented in a web page of the UPPS Site similar to the example web page 2101 depicted in FIG. 21. On this page 2101, the actual wording 2109 of the given plank appears, along with a number of additional pieces of information, such as a plank status identifier 2110, which indicates whether the plank is pending, rejected, or adopted as part of the party's platform.

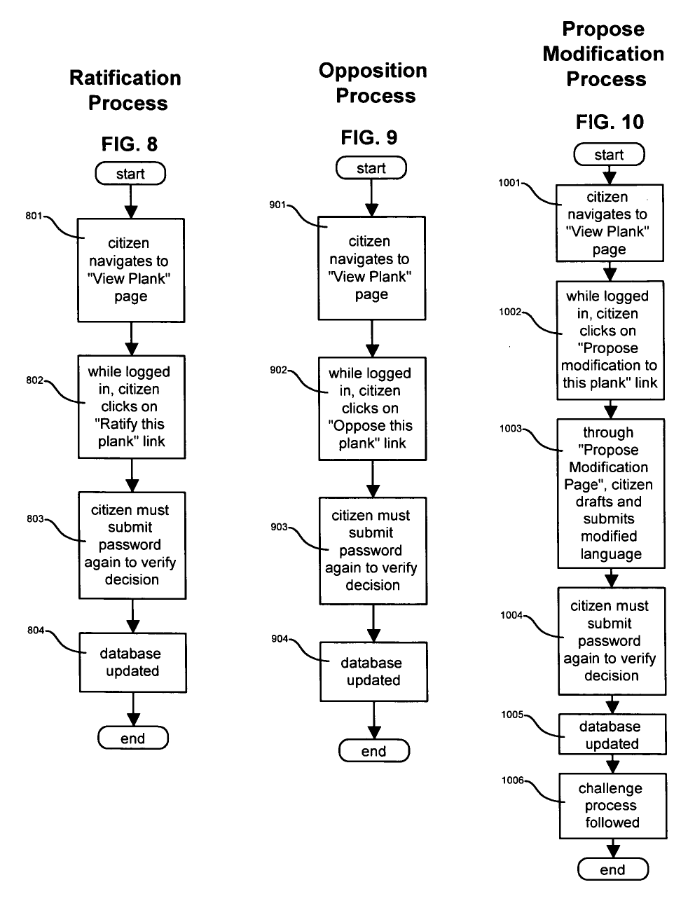

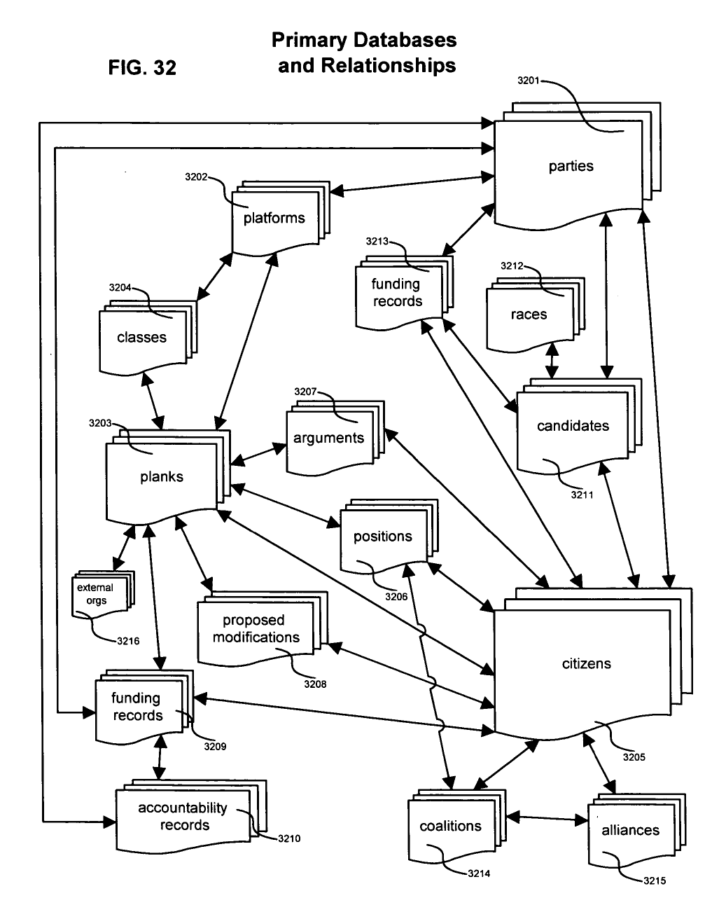

If the citizen finds a plank that he or she believes should be included in the party's platform, he or she can convey this approval by “ratifying” 710 the plank through a disclosed plank ratification process depicted in FIG. 8. After reviewing 801 the plank through the “View Plank Page” 2101 in FIG. 21, the user clicks 802 on the disclosed “ratify this plank” link to signify that he or she wishes to commit to a “ratify” position on this plank. The citizen is then required to login, if he or she has not already done so, and submit 803 his or her password to verify that the decision to ratify the plank is actually being made by the account holder. Upon such submission, a new record is created 804 in the positions database 3206 in FIG. 32, and the user's choice to ratify this plank is stored 804 in the new record.

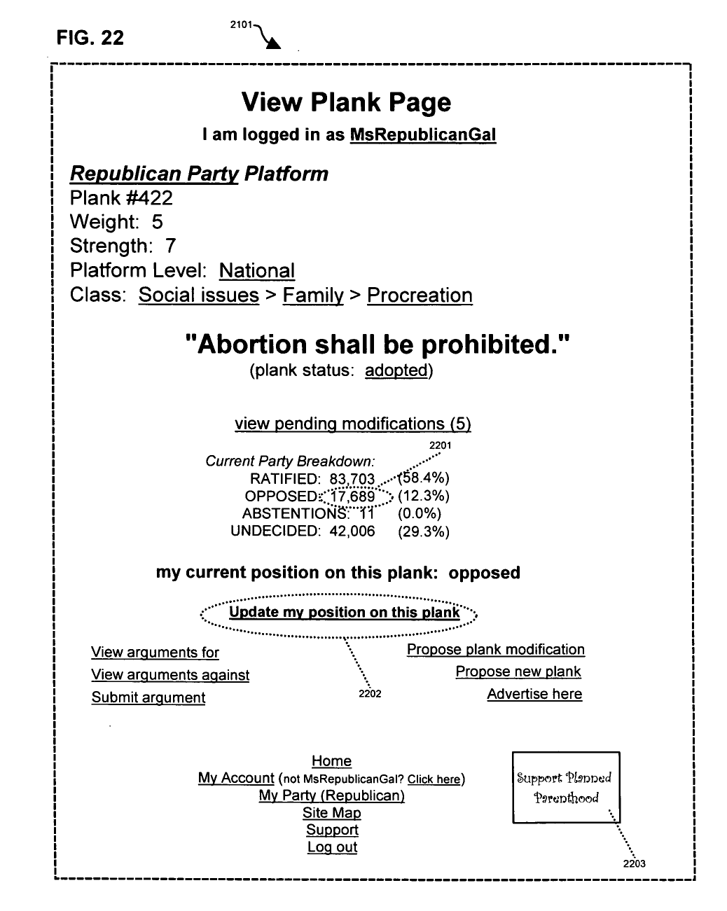

If the citizen finds a plank that he or she believes should be excluded from the party's platform, he or she can “oppose” 712 this plank through a disclosed opposition process depicted in FIG. 9. Once a citizen has taken a position (ratification, opposition, abstention) on the plank, the position record in the positions database 3206 is created or updated and the information displayed through the page 2101 changes. Thus, for instance, FIG. 22 depicts the example page 2101 that is depicted in FIG. 21 after the citizen has opposed the depicted plank by following the opposition process depicted in FIG. 9, such that the number 2201 of party members opposing the plank has increased by one unit.

Sometimes, users may find that, while they agree with a plank, the wording of the plank is not quite accurate or precise. In such a case, the citizen can follow 714 the plank modification proposal process depicted in FIG. 10. Note that the “challenge process” to be followed in the last step 1006 can essentially be conducted as a separate vote, whereby users who have taken a position on a given plank can choose which proposed modifications to the particular wording of a given plank should be made.

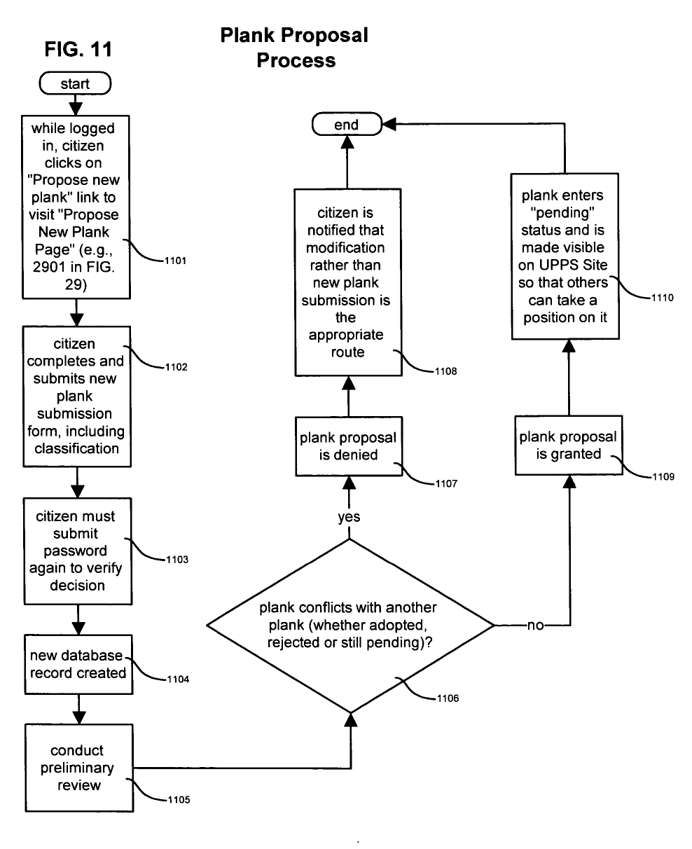

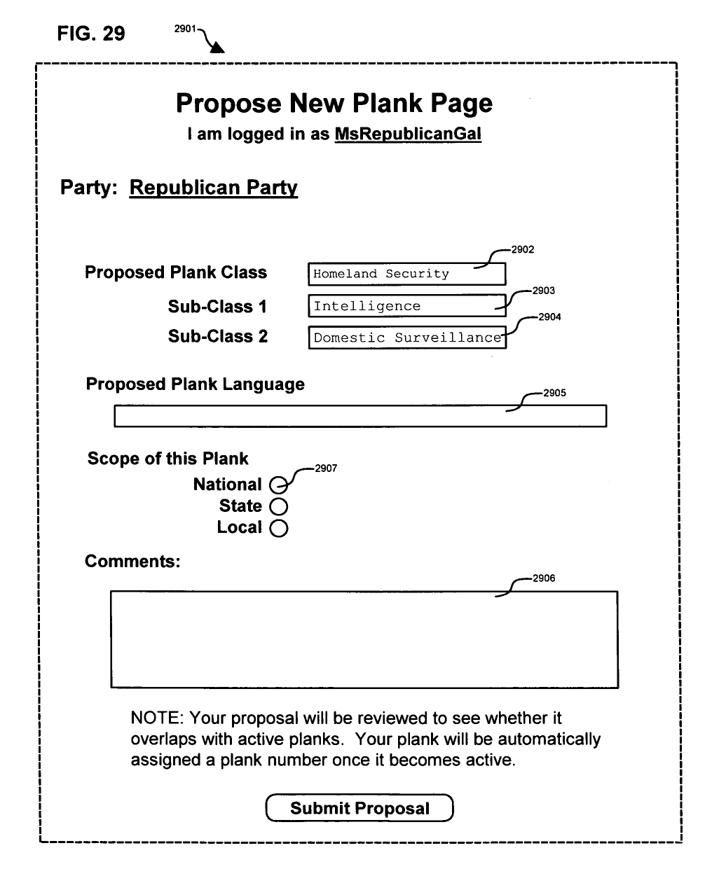

If, however, the citizen finds that no one has yet suggested a plank that he or she believes should be a part of the party's platform, he or she may propose a new plank 716 by visiting a “Propose New Plank Page” 2901 in FIG. 29 and following a plank proposal process disclosed in FIG. 11. Also, if at some point the user changes his mind on a particular issue and this issue is the subject of a plank on which the user has already committed to a position, the citizen may change his or her position on the given plank by following 720 the position update process depicted in FIG. 13.

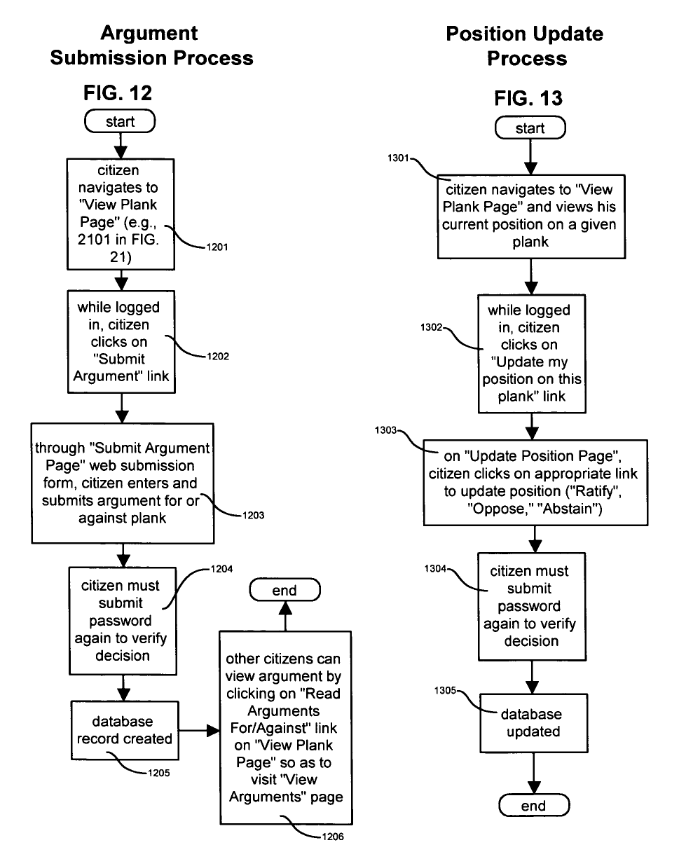

On occasion, a citizen may wish not only to take a position on a plank but also to influence others' opinions. In such a case, he or she may submit an argument 718 that will be visible to others on the UPPS Site by following the argument submission process depicted in FIG. 12.

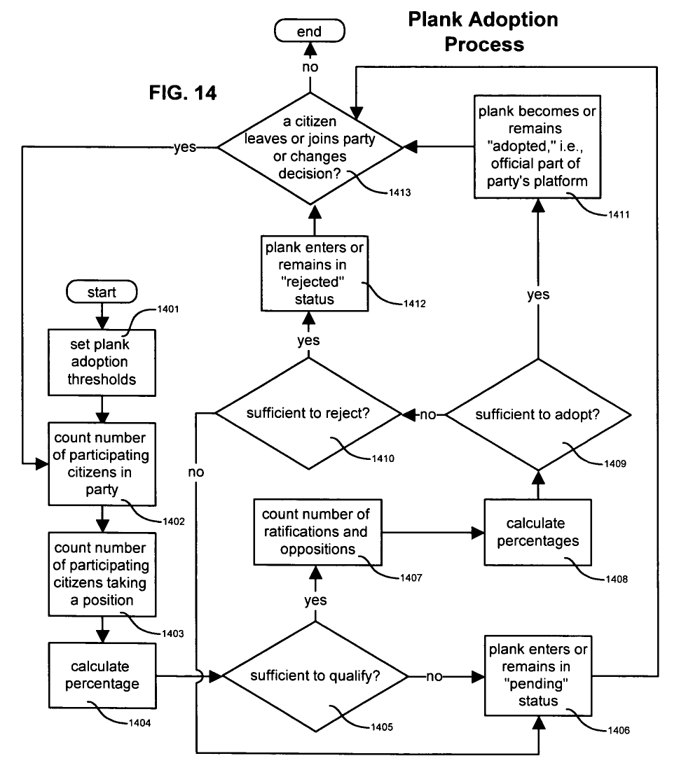

Whenever a user of the UPPS Site takes or changes a position on a plank or a new user account becomes active, the majority of the plank adoption process depicted in FIG. 14 must be executed 721 so as to calculate the status of the plank in light of the new data (e.g., an increase in the number of registered party members or an altered position). First, prior to making the UPPS Site available to the public, the Organization determines 1401 three plank adoption thresholds: (i) an absolute quorum threshold, which is a minimum quantity of members of a political party who must have registered on the UPPS Site before any plank can be adopted at all by that party; (ii) a relative quorum threshold, which is a minimum percentage of all members of a party on the UPPS Site that must have taken a position on a given plank in order for it to qualify to be adopted or rejected; and (iii) an action threshold, which is a minimum percentage of party members taking a position on the plank who have committed to a particular position (ratify or oppose) on the plank, which threshold must be met or exceeded (either by “ratify” positions or “oppose” positions) in order for that plank to become officially adopted or rejected.

Thereafter, every time relevant data changes the rest of the process in FIG. 14 must be followed. The number of citizens with active UPPS Site accounts in a given party is counted 1402; the number of such party members taking a position on a given plank is counted 1403; the percentage of party UPPS Site members taking a position is calculated 1404; if the quorum thresholds are not both met 1405, the plank enters or remains in “pending” status, i.e., it is neither yet adopted or rejected by the party. If the quorum thresholds are both met 1405, the number of party members taking the position of “ratify” on this plank is counted 1407; the percentage of site party members ratifying the plank out of those taking a position on the plank is calculated 1408; if this percentage is high enough 1409 to meet the action threshold, the plank enters or remains in “adopted” status 1411, i.e., it becomes an official part of the party's platform. If not, the number of party members taking the position of “oppose” on this plank is counted 1410; if this percentage is high enough to meet the action threshold, the plank enters or remains in “rejected” status 1412. If not, the plank enters or remains in “pending” status 1406. Each time any of the numbers used in the quorum and adoption calculations are changed 1413—by people joining or leaving the party, taking or changing positions, etc.—, these steps are repeated to determine the new status of each plank.

Occasionally, as a result of this process, a plank that had once been “adopted” can fall back into “pending” status.

One primary virtue of the UPPS is that it allows the degree to which a given candidate for office actually represents the views of the people in his or her party to be quantified very accurately and precisely.

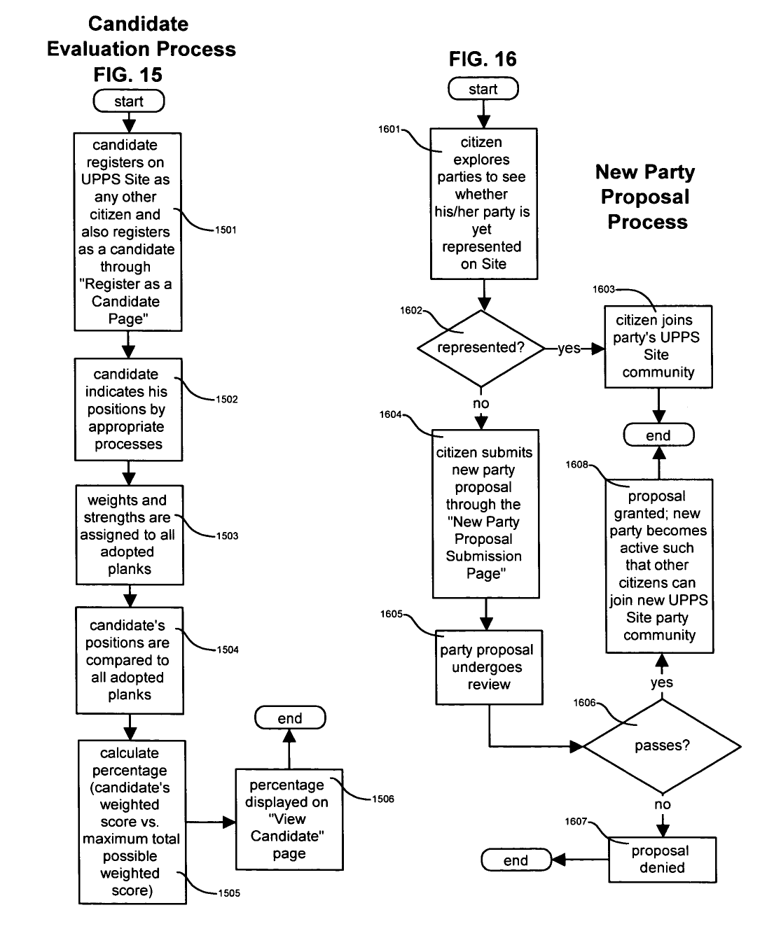

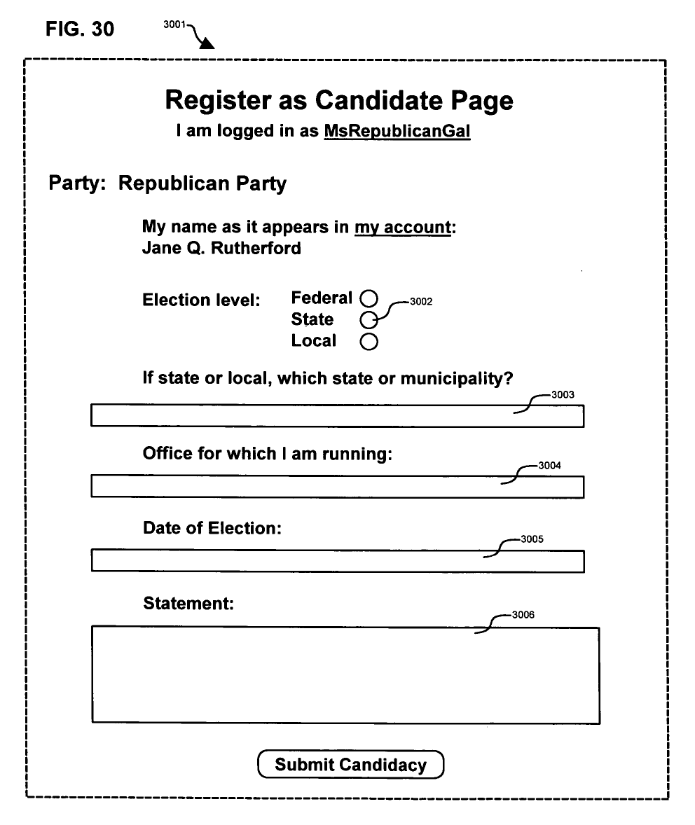

A process of evaluating a candidate in terms of representativeness of his or political party's members' views is disclosed in FIG. 15. After registering 1501 on the UPPS Site like any other party member, a candidate for office also registers 1501 as a candidate on the UPPS Site through a “Register as a Candidate Page” 3001 in FIG. 30. Thereafter, the candidate indicates 1502 his position (ratify, oppose, or abstain) on all planks that have been officially adopted as part of the party's platform. Each plank is assigned a “weight” measurement and a “strength” measurement 1503. The weight measurement indicates, on a scale of one through nine, how many people in the party have taken a position on the plank (e.g., if 100,000 members have taken a position, the weight of the plank is “5”; if more than 5 million members have taken a position, the weight of the plank is “9”). The strength measurement indicates, on a scale of one through nine, how unanimous the party is with respect to its adoption or rejection of a given plank (e.g., if those ratifying the plank outnumber those opposing the plank by a ratio of roughly five-to-one, the strength of the plank is “7”; if such ratio is ten-to-one or greater, the strength is “9”).

The candidate's positions on all planks are compared 1504 with all adopted planks, factoring in the weight and strength of planks, so as to produce 1505 a percentage, that percentage being the ratio between “points” scored by the candidate every time he or she agrees with the party membership and the total number of points the candidate could have scored had he or she agreed with the party membership on every single plank. For instance, when a candidate agrees with the party on a plank with a strength of 2 and a weight of 5, he gets (2×5=) 10 points. When he disagrees with the party, he gets no points. Alternately, the candidate can simply be given a raw, unweighted score, receiving one point for every plank where he agrees with the party's platform.

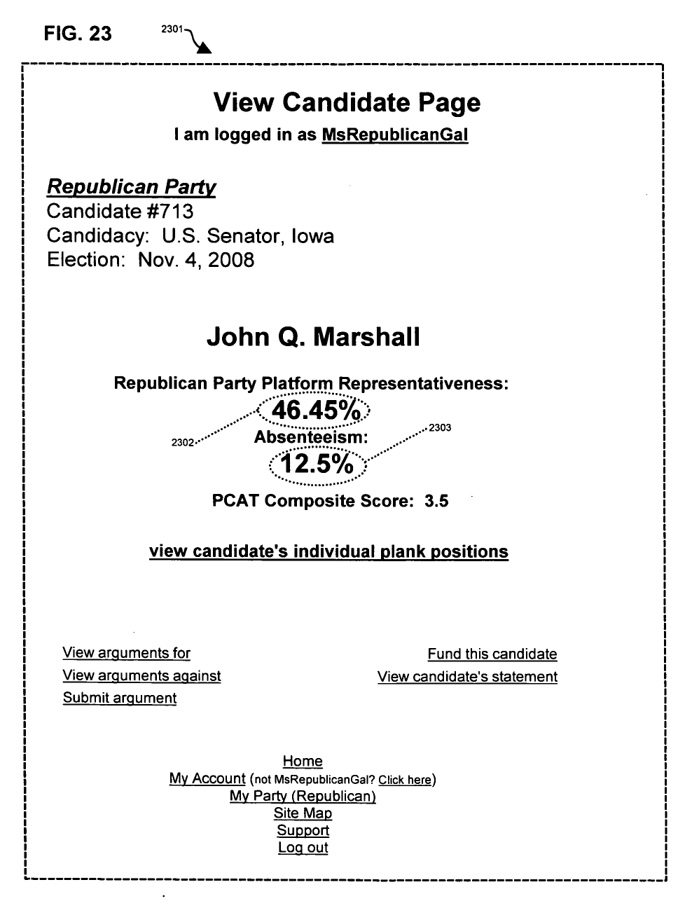

The resulting percentage is then displayed 1506 on the “View Candidate Page” 2301 in FIG. 23 as a representativeness percentage 2302 so as to be viewable to UPPS Site users. Also, this page 2301 displays an absenteeism indicator 2303, which is a percentage of the days when the candidate, as an incumbent (if applicable), did not come to work out of all the workdays available during the incumbency. Reporting of days not worked can be done by an independent task force assigned by Organization for that task, which report can be verified or contested by members of the public at large as needed.

Occasionally, a citizen may find that the UPPS Site does not include his or her political party. In such a case, he or she can follow a disclosed new party proposal process as depicted in FIG. 16. When a new party is proposed 1604, it undergoes review 1605 by the Organization, which verifies that the proposed party is actually registered as a political party in at least one relevant jurisdiction. If the new party proposal passes 1606, the new party becomes “active” such that other UPPS Site users can indicate their membership in the new party by joining the party's community on the UPPS Site and can begin building its platform on the UPPS Site as per processes depicted elsewhere.

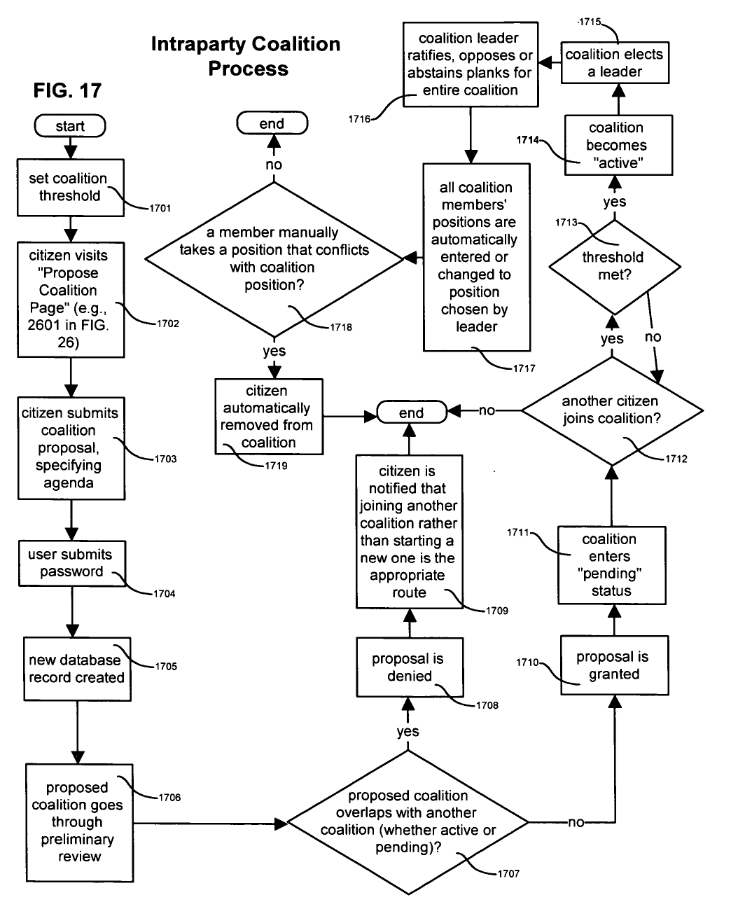

Some members may find that they do not have enough time to stay abreast of all political issues facing their party and to consider all planks that are suggested by other site users. Others may wish to maximize the participation and effectiveness of like-minded users by forming voting blocs. To accommodate both of these concerns, an intraparty coalition process is disclosed in FIG. 17.

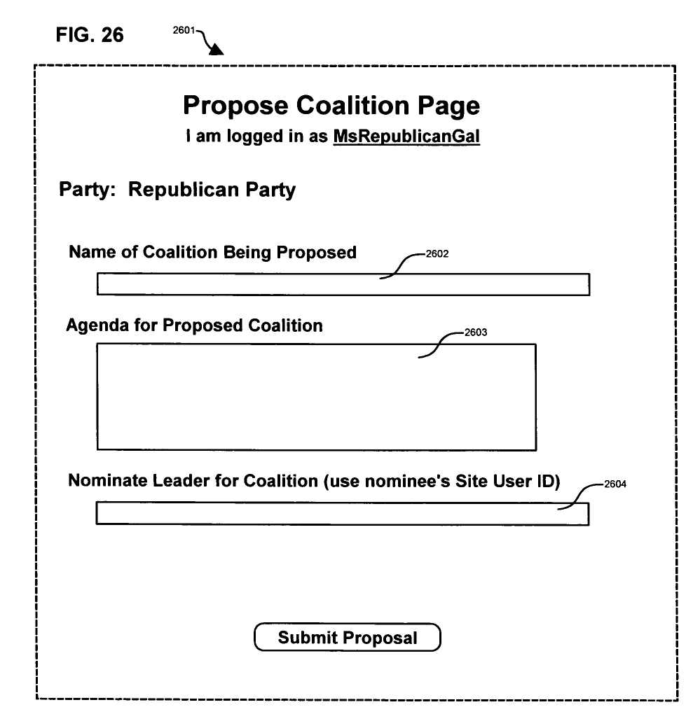

First, prior to making the UPPS Site available to the public, the Organization defines 1701 a coalition threshold, which is a minimum quantity of users who must join a coalition before it becomes “active”. Once the UPPS Site has been made available, a citizen visits 1702 a “Propose Coalition Page” 2601 in FIG. 26, fills out required fields (such as coalition name 2602, agenda 2603, and a nominated leader for the coalition being proposed 2604) and submits 1703 the completed Web submission form. The user may be required to resubmit his or her password 1704 before the proposal is accepted. Thereafter, a new database record is created 1705 in a coalitions database 3214 in FIG. 32, in which is stored the information submitted by the user.

The proposed coalition then goes through preliminary review 1706 by the Organization to see whether 1707 the newly proposed coalition overlaps with an existing active or pending coalition. If so, the proposal is denied 1708 and the user is notified 1709 by e-mail or through a message displayed on the UPPS Site that he or she should join the pre-existing coalition rather than start a new one. If not, the proposal is granted 1710, and the coalition enters 1711 “pending” status. Once another citizen joins the coalition 1712, the total membership of the coalition is compared 1713 to the previously determined coalition threshold. If this threshold is met, the coalition becomes “active” 1714. Once active, the coalition can elect a leader 1715. Optionally, the Organization may wish to limit the number of coalitions to which a single user can belong at one time, so as to incentivize thoughtful coalition-building and discourage frivolous coalitions.

The power of the coalition can be tapped once a leader is elected. This power works as follows: the leader can commit 1716 the coalition to a position (either ratify, oppose, or abstain) on individual planks. When he or she does so, each individual member of the coalition is automatically committed 1717 to the position of the coalition just as though that individual member had actually taken that position directly himself or herself through the “ratify plank” process FIG. 8 or the “oppose plank” process FIG. 9. Any positions a user has taken on a plank prior to joining a coalition or prior to the leader's commitment to a position on that plank are automatically overridden and changed to the position of the coalition at the time the user joins or at the time the leader commits the coalition to a position on that plank. In this way, the voting power held by an individual member can be wielded by the leader of the coalition without the need for continuing involvement of the individual member.

Individuals can voluntarily leave a coalition at any time, but leaving a coalition will not retract or alter any positions already automatically entered on behalf of that user. He or she can manually override 1718 any automatically entered positions, but, if he or she does so while still a member of the coalition, he or she will be automatically removed from the coalition 1719 at the moment of commitment to a position that departs from that of the coalition.

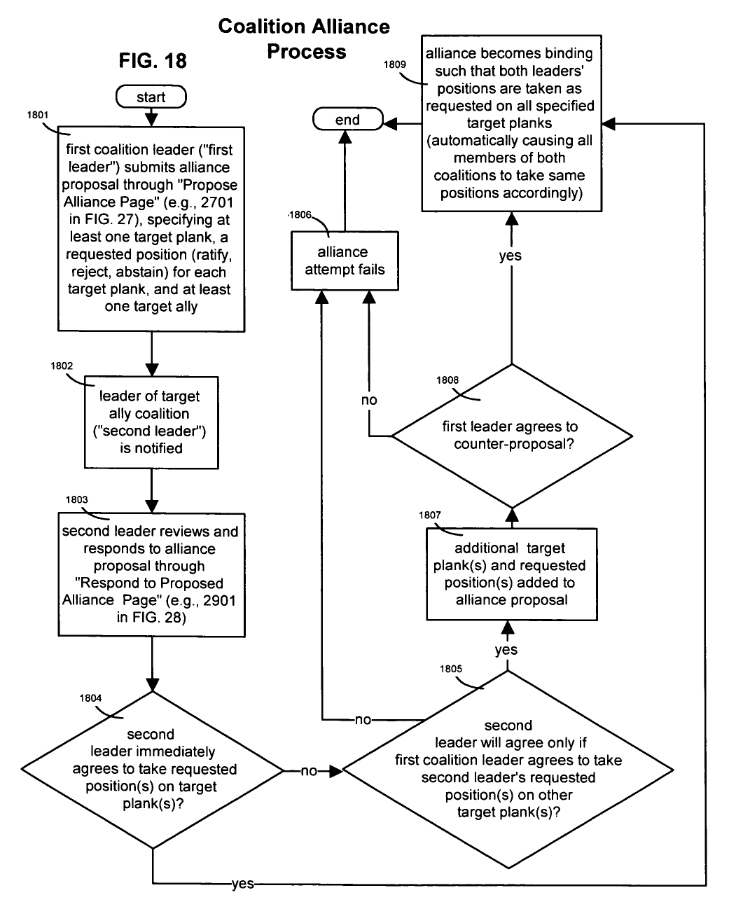

A major benefit of forming a coalition is that, in so doing, the members of the coalition create bargaining power that can then be leveraged by their leader through negotiations and alliances with the leaders of other coalitions. Toward that end, a coalition alliance process is disclosed in FIG. 18.

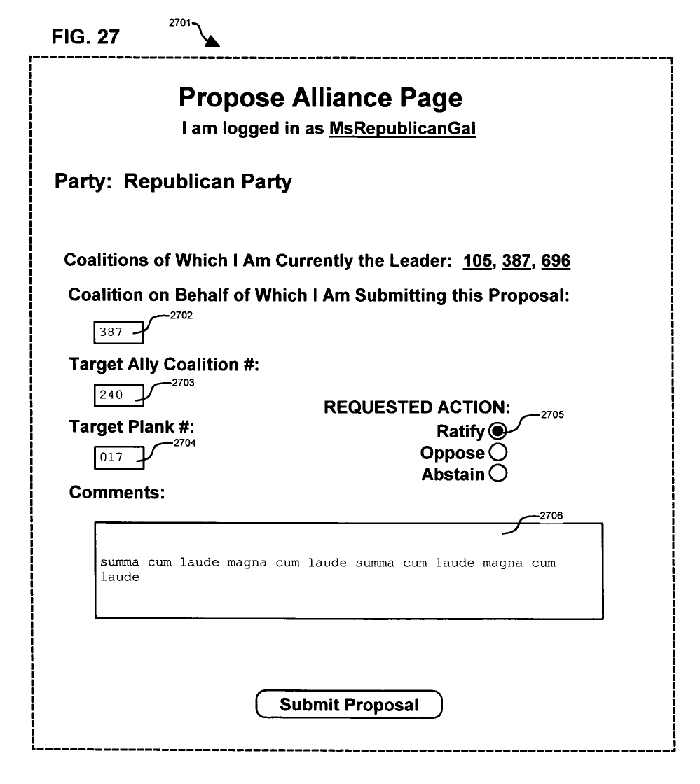

A first coalition leader visits 1801 a “Propose Alliance Page” 2701 in FIG. 27 and enters data into the fields of a Web submission form included therein, such as: a field 2702 in which to specify the coalition being represented in this transaction by the proposing leader, a field 2703 in which to specify the coalition being approached for alliance, a field 2704 in which to specify the plank involved in the transaction, and a field 2705 in which to specify the requested action to be taken. A comments field 2706 is also provided so that the proposing leader can introduce himself or herself to the leader of the coalition being approached, as well as present an argument for why the second leader should agree to the alliance.

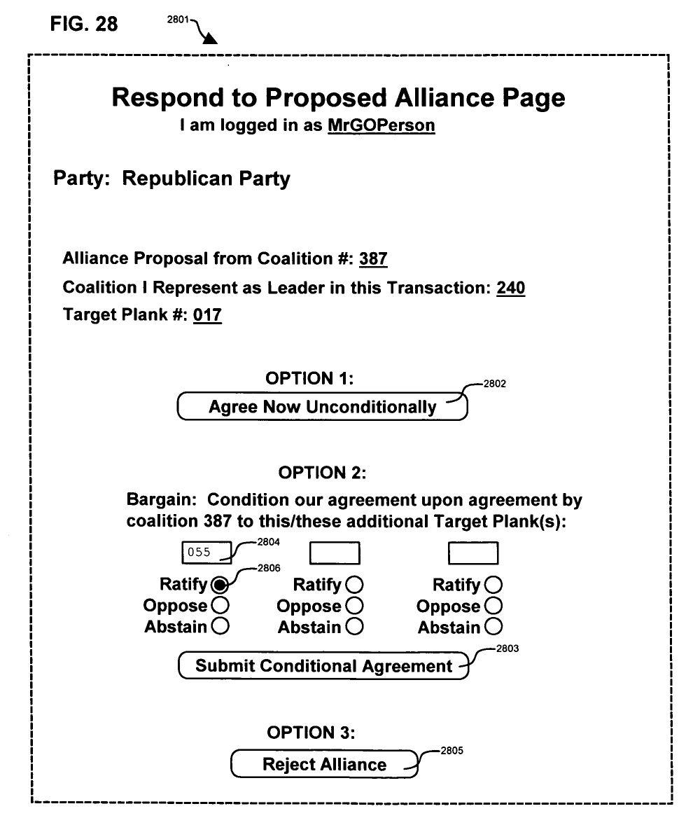

Once this page has been completed and submitted 1801, the leader of the target ally coalition is notified 1802 by e-mail or publication on the UPPS Site. The latter leader then reviews the proposal and responds through a “Respond to Proposed Alliance Page” 2801 in FIG. 28. Through this page 2801, the second leader has the option of immediately agreeing 1804 to the alliance by clicking on the appropriate button 2802, rejecting the alliance immediately by clicking on the appropriate button 2805, or conditioning 1805 agreement to the alliance upon agreement by the proposing leader to commit to additional positions by counter-proposing at least one additional target plank 1807 in the appropriate field 2804 and an action to be taken on that plank (ratify, oppose, abstain) and then clicking the appropriate button 2803. In the latter case, if the proposing leader subsequently agrees 1808 to the counter-proposal, the alliance is formed and both coalitions are automatically committed to the specified target planks 1809. Otherwise the alliance attempt fails 1806.

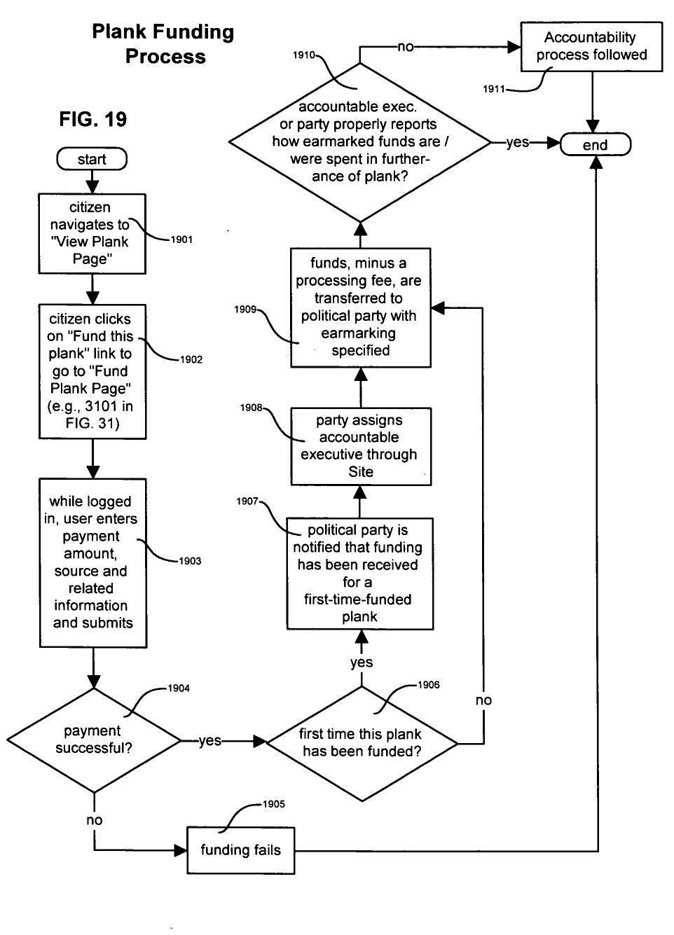

Some users may feel strongly enough about a given plank that they wish to donate funds to their political party earmarked for promotion of the party's prevailing position on that plank. So as to make such earmarked donations possible, a plank funding process is disclosed in FIG. 19.

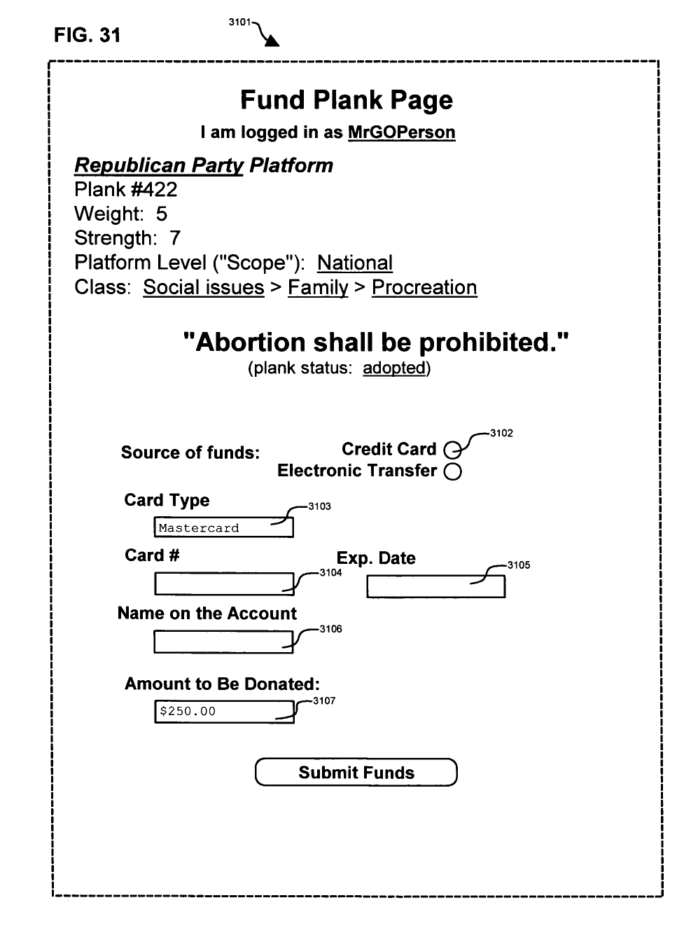

After navigating 1901 to the “View Plank Page” 2101, a user clicks 1902 a “Fund this plank” link 2116 so as to visit a “Fund Plank Page” 3101 in FIG. 31. The user enters 1903 data into required fields, including a field 3102 for specifying a source of funds, an amount to be donated field 3107, and related payment fields (account number, name, etc.) and submits this information by clicking a “donate funds” button. If the payment is processed successfully 1904 and this payment is the first time that the given plank has been funded 1906, the Organization notifies 1907 the political party being funded that funding has been received for a previously unfunded plank. The political party then assigns 1908 someone within its ranks to be accountable for the handling of funds earmarked for the given plank, an “accountable executive.” Once the accountable executive for the given plank has been assigned, the earmarked funds submitted by the citizen are transferred to the political party 1909, while the Organization deducts from these funds a processing fee that is retained by the Organization to cover its own operating costs.

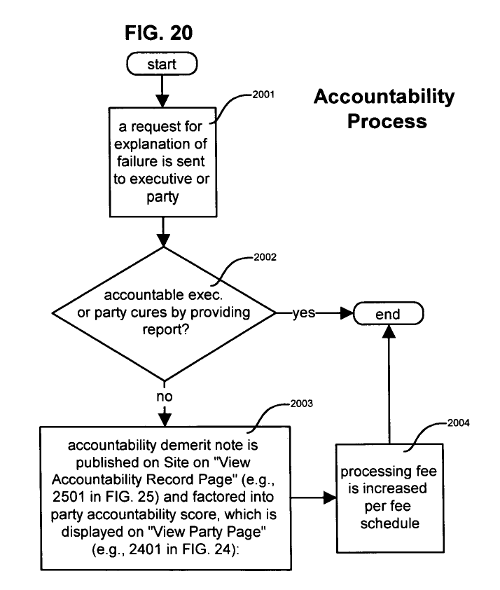

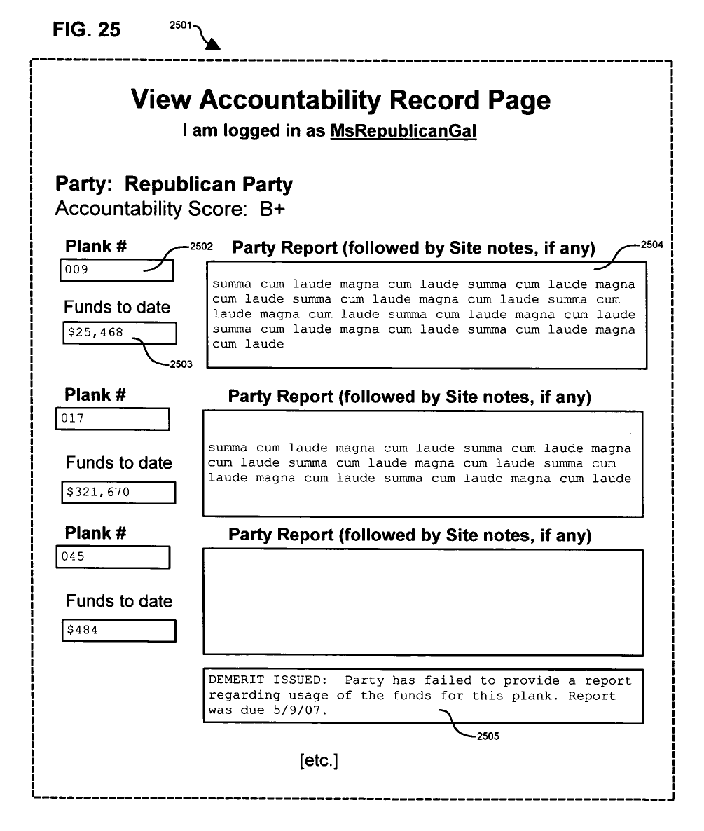

After the political party has received the funds, it has an ongoing duty owed to the Organization, the UPPS Site community, and the individual who has donated the funds to report 1910, through the UPPS Site, how the earmarked funds are spent until the funds have been completely disbursed. These reports can be viewed by the UPPS community through a “View Accountability Record Page” 2501 in FIG. 25. However, if the accountable executive and the party itself fail to provide a report as required, an accountability process disclosed in FIG. 20 is followed 1911 so as to hold the political party accountable to its constituents who are part of the UPPS community.

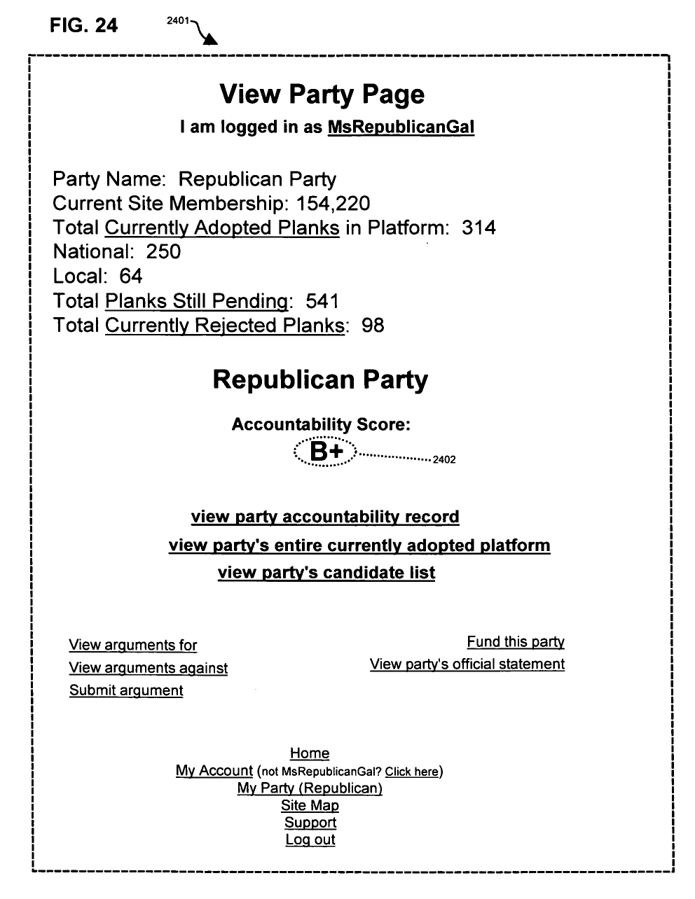

According to the accountability process, once a report from the accountable executive becomes past due, the Organization requests 2001 that the accountable executive explain the failure. If the accountable executive or another member of the party then reports 2002 as required, all is well. If not, the Organization issues 2003 a demerit to the party and publishes a note regarding its default in its reporting duty on the UPPS Site, in particular, on the “View Accountability Record Page” 2501. This demerit is also factored into an accountability score 2402 displayed in a “View Party Page” 2401 in FIG. 24. The Organization may also set a demerit-fee schedule such that, if a political party receives a certain number of demerits, the processing fee that the Organization deducts from funds donated through the UPPS Site to the party may be increased 2004. Examples of the pages disclosed are depicted in FIG. 21 et seq. An example “View Plank Page” 2101 includes an indicator 2102 of the user ID of the account into which a user has logged during a particular browser session; the name of the party 2103 of which the user is a member; a unique serial number 2104 that identifies the plank being displayed; a weight indicator 2105; a strength indicator 2106; a platform level indicator 2107, indicating whether the plank is part of the party's platform at the national level, the state level, or the local level. Also displayed in this page is the language 2109 of the plank itself; a status indicator 2110, showing whether the plank is currently in “adopted” status, “rejected” status, or “pending” status; a link 2111 which a user can click to view proposed modifications to the language of the plank; a breakdown 2115 of the current party membership's positions, including the quantities and percentages of people ratifying the plank, opposing the plank, abstaining, and who are yet undecided.

A current position indicator 2113 shows what position the currently logged-in user has taken, if any, on this plank. Links to additional pages and processes pertaining to this plank, such as an “oppose this plank” link 2114, whereby a user can indicate his or her opposition to the plank, and a “fund this plank” link 2116 are also displayed.

After a user takes a position or changes a position with respect to the given plank, the page 2101 is updated to reflect this change, as depicted in FIG. 22, in which a new total 2201 of users opposed to the given plank is shown, the user's current position indicator has changed, and an “update my position on this plank” link 2202 appears. As other disclosed pages, this page 2101 is dynamically generated, and variable information is drawn from relevant databases (see FIG. 32). An advertisement 2203, paid for by a third party, may also be displayed that is targeted toward the demographic likely represented by someone who would take the position taken on the particular issue. For instance, if someone ratifies a plank stating that government funding for music education in schools should be increased, he or she is shown an ad pertaining to a music concert, venue, recording, instrument or educational program. An “advertise here” link may also be included so that advertisers are made aware that they can advertise on the “View Plank Page”.

The disclosed “View Candidate Page” 2301 in FIG. 23 displays various relevant pieces of information regarding a particular candidate, including his or her name, a unique candidate serial number that is automatically assigned upon UPPS registration as a candidate, political party, the race in which he or she is running, the date of the election, representativeness indicator 2302, absenteeism indicator 2303, PCAT score, and a number of links to related information, such as to a list of the candidate's positions on individual planks in the party's platform and to a statement previously submitted by the candidate through the “Register as a Candidate Page” 3001.

The disclosed “View Party Page” 2401 in FIG. 24 displays various relevant pieces of information regarding a particular political party, including the party name, total number of members of the party who have active accounts on the UPPS Site, total number of currently adopted planks in the platform of the party, accountability score 2402 of the party, and other information and links. Funds that are not earmarked for promotion of any particular plank may be submitted for general use by the party through this page 2401.

The disclosed “View Accountability Record Page” 2501 in FIG. 25 displays clusters associated with individual planks that have been funded, wherein each cluster contains an indicator of the individual plank serial number 2502, an indicator of the total funds that have been donated to support that plank to date 2503, and a report previously submitted by the accountable executive or the party itself describing how the funds have been used to date 2504. If a particular report is delinquent, a demerit indicator 2505 is displayed in the cluster pertaining to the plank of which the report is delinquent.

The disclosed “Propose New Plank Page” 2901 in FIG. 29 includes a number of fields suitable for entry of data by a user, including a pop-up menu 2902 from which a user can select a class into which the proposed plank can be grouped, as well as two subclass pop-up menus 2903 and 2904. Also included are a field 2905 in which the user enters the actual language of the proposed plank, a field 2906 for comments, a field 2907 for choosing the scope (national, state or local) of the plank being proposed, and a submit button.

Important databases and key relationships between databases in a relational database complex for use with the UPPS Site are disclosed in FIG. 32. Many of the relationships are many-to-one. For instance, a single citizen account record in a citizens database 3205 is often related to many records in a positions database 3206, since citizens often take positions on many planks. Similarly, a single plank record in a planks database 3203 is often related to many records in the positions database 3206, since multiple citizens can take positions on a single plank. Databases and individual records therein can be related to one another by known relational database management system techniques, such as using a “key” field: when data in the key field of a record in one database matches data in the key field of a record in another database, the two records are related.

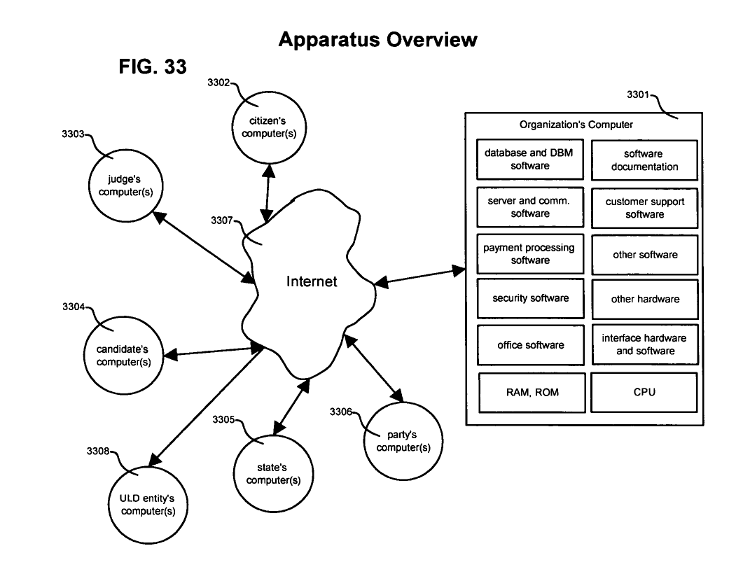

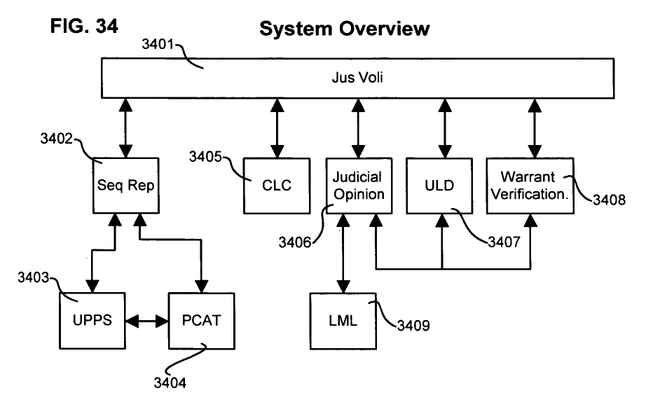

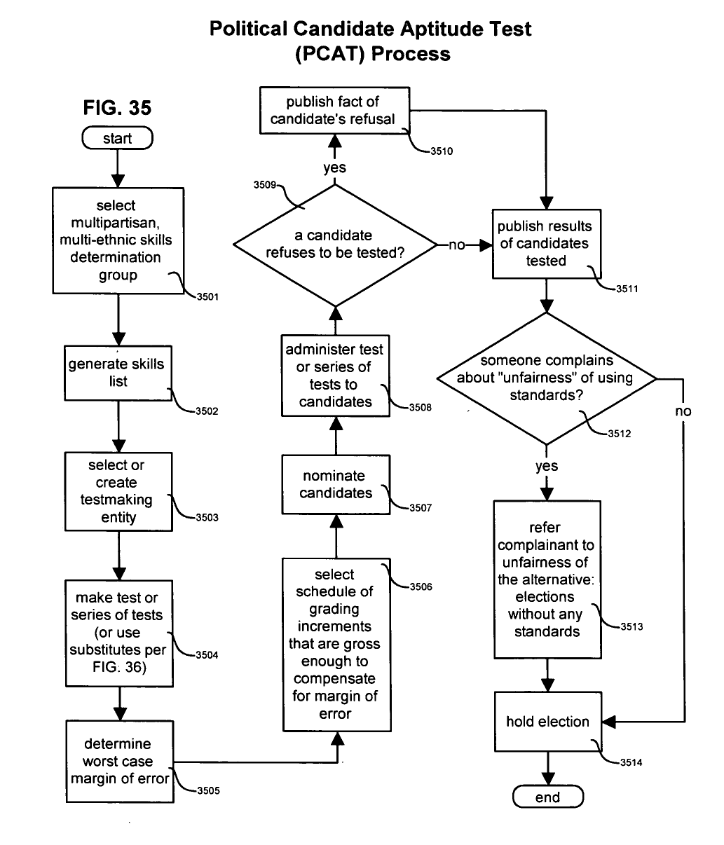

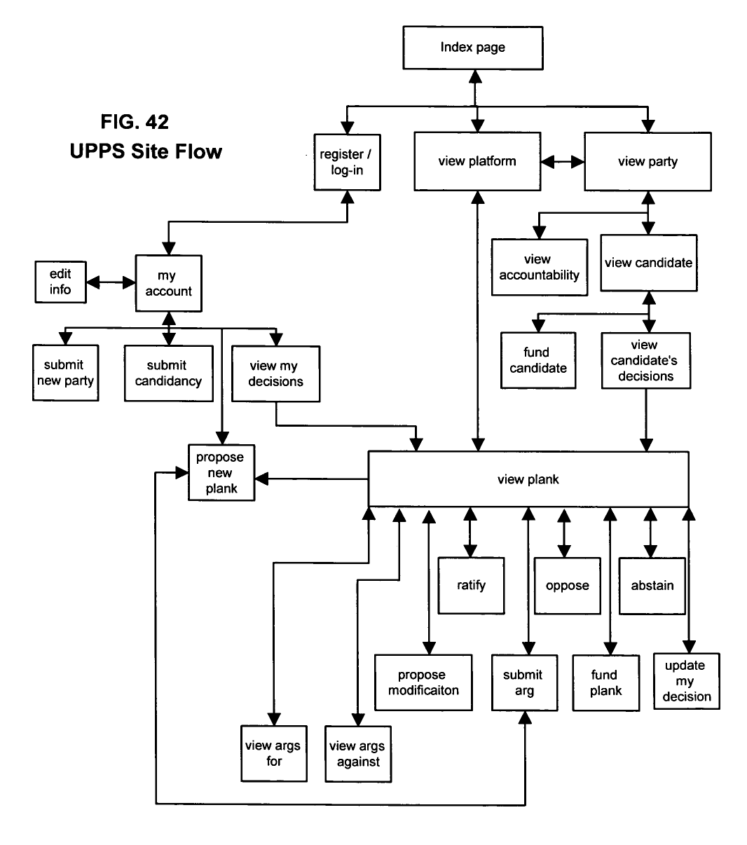

A general overview of the physical apparatus, including hardware of the Organization as well as that owned by other participants in the disclosed system and processes, appears in FIG. 33. Hardware owned by various participating individuals, entities and groups communicate with each other through the Internet 3307, which in turn involves a number of pieces of hardware under the ownership and control of entities not depicted individually in the diagram. A general overview of the interplay between the various component systems of the present invention is disclosed in FIG. 34. A site flow diagram for the UPPS site appears in FIG. 42. The disclosed plank system may also be reconfigured for use in fundraising efforts by other groups that wish to have a user-maintained agenda.

Part IV: Political Candidate Aptitude Test (PCAT)

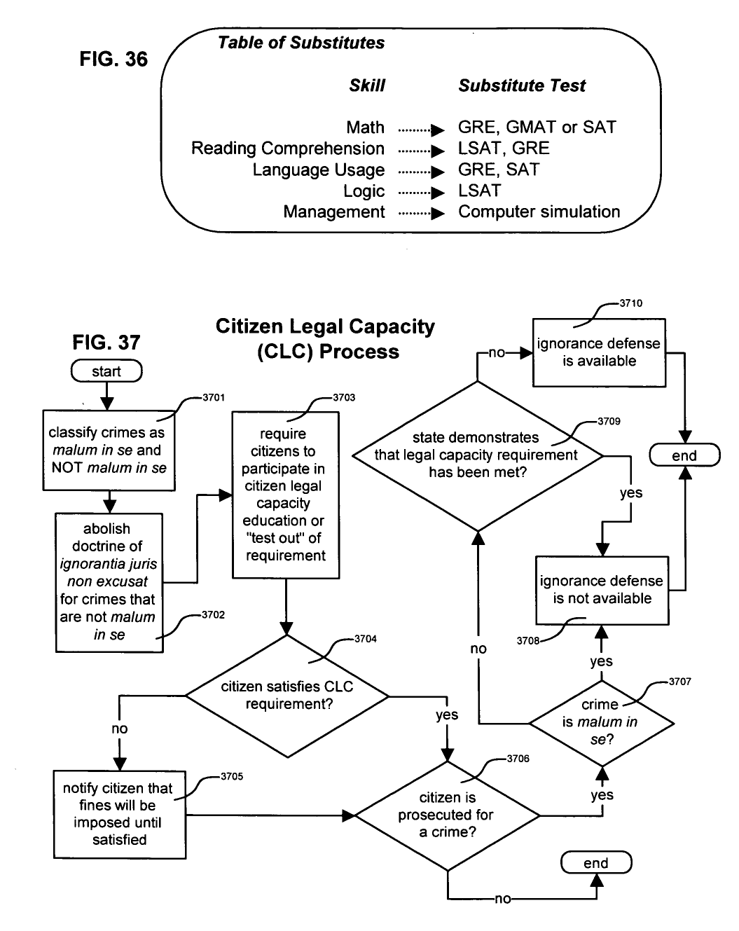

Under the present invention, a group consisting of representatives from diverse political parties, socioeconomic backgrounds, and racial and ethnic groups is selected 3501 either by popular election or appointment. The group then drafts 3502 a list of skills necessary to effectiveness as a political officeholder. The group then selects 3503 a qualified test-making organization, or, if none exists, creates one 3503. The test-making organization then creates 3504 a test or a series of tests designed to measure the skills on the list, or, if it is unwilling or unable to create a series of tests, it may choose to use pre-existing tests as substitute measures of candidate skills per the suggestions depicted in FIG. 36.

The test-making organization then projects 3505 what the most pessimistic margin of error for each part of the test may be. The test-making organization then selects 3506 a grading scale that uses grade increments that are large enough to reasonably compensate for the worst expectation of margin of error. For instance, if a math skills section is included in the PCAT and the most pessimistic estimate of the margin of error in its measuring of actual math skill is +/−5%, then a grading scale is selected in which grade increments are gross enough to reasonably compensate for this margin of error. For instance, in this example, a grading scale that used only integers ranging from one to five would be satisfactory: very poor math skills would receive a 1, below average would receive a 2, average would receive a 3, above average would receive a 4, and excellent would receive a 5. This grading scale is so gross in its increments that opponents of the PCAT would be hard-pressed to assert that it is unfair, discriminatory in impact or intent, or otherwise invalid.

Candidates for the office are nominated 3507, and then each candidate takes the test or tests 3508. If a candidate refuses 3509 to take the PCAT, his or her refusal is published 3510 so that the public is at least made aware that the candidate is unwilling to participate; it is probably advisable to allow refusing candidates to still appear on the ballot, although making the PCAT mandatory may be considered. The results obtained by candidates who do take the PCAT are then published 3511, through the UPPS Site or through any other medium, so that the public can make an informed choice regarding the relative skills of candidates. No minimum score is required, and there are no repercussions for poor performance except the significance that voters themselves attach to results.

It is probable that someone will consider the very use of an objective measure of skill to be “unfair” 3512, even though objective measures (e.g., bar exam) have long been used in virtually every profession—medicine, law, etc.—except politics. In the event of such a complaint, the complainant can be asked whether judging candidates on skills can honestly be considered less fair than judging them on sheer popularity, as under the related art. Moreover, popularity will always remain a predominant factor in elections, despite usage of the PCAT, such that proponents of popularity-only elections need not be too alarmed. Finally, the complainant is reminded that the public is free to discount or ignore the results of the PCAT if they actually believe the PCAT to be unhelpful or unfair. The election is then held 3514.

Part V: Citizen Legal Capacity Development System

Under the present invention, legislators elected through the processes described above review the penal code of a jurisdiction and classify all crimes codified therein as malum in se or not malum in se 3701. By statute, the legislature then abolishes the doctrine of ignorantia juris non excusat for crimes that are classified as not malum in se 3702, thereby allowing the availability of ignorance of the law as an affirmative defense.

So as to serve multiple purposes, such as deterrence of crime and legitimate enforcement of the penal code, the legislature requires citizens to participate in a “Citizen Legal Capacity” (CLC) information program or to “test out” of this requirement 3703. If a citizen does not fulfill the requirement 3704, which requires attendance of one or more seminars during which attendees are informed of what criminal laws are on the books, that citizen is notified that he or she will be subject to an annual fine until the requirement is met 3705.

Thereafter, if a citizen is prosecuted 3706 for a crime, and the crime is not malum in se 3707, the prosecution must demonstrate 3709 that the defendant has satisfied the legal capacity requirement with respect to that crime, i.e., the defendant has been informed of the existence of the law that he or she is accused of breaking; otherwise, the ignorance defense is available 3710 to the defendant in that case. (If the ignorance defense is raised, the prosecution may still prove actual knowledge to overcome the defense.) If the state has met 3709 the requirement or the crime is malum in se 3707, the ignorance defense is not available 3708.

Instead of using a “stick” to incentivize people to participate, the state can use a “carrot”, e.g., an additional tax refund payable to the citizen upon completion of the program. Citizens who wish to do so may “test out” of the CLC program by taking a test that indicates their knowledge of the criminal code; if a citizen performs well enough on such a test, he or she has officially satisfied the requirement without having to attend the seminar (and would by doing so be entitled to whatever financial incentive is offered to those who do attend the seminar).

Part VI: Suspect-Verifiable Warrant

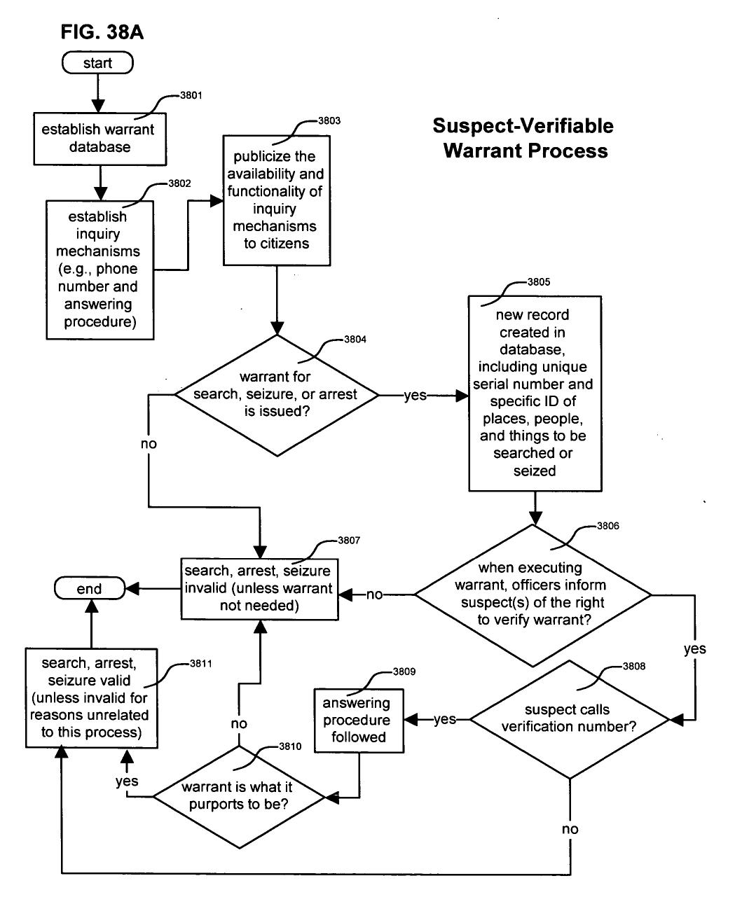

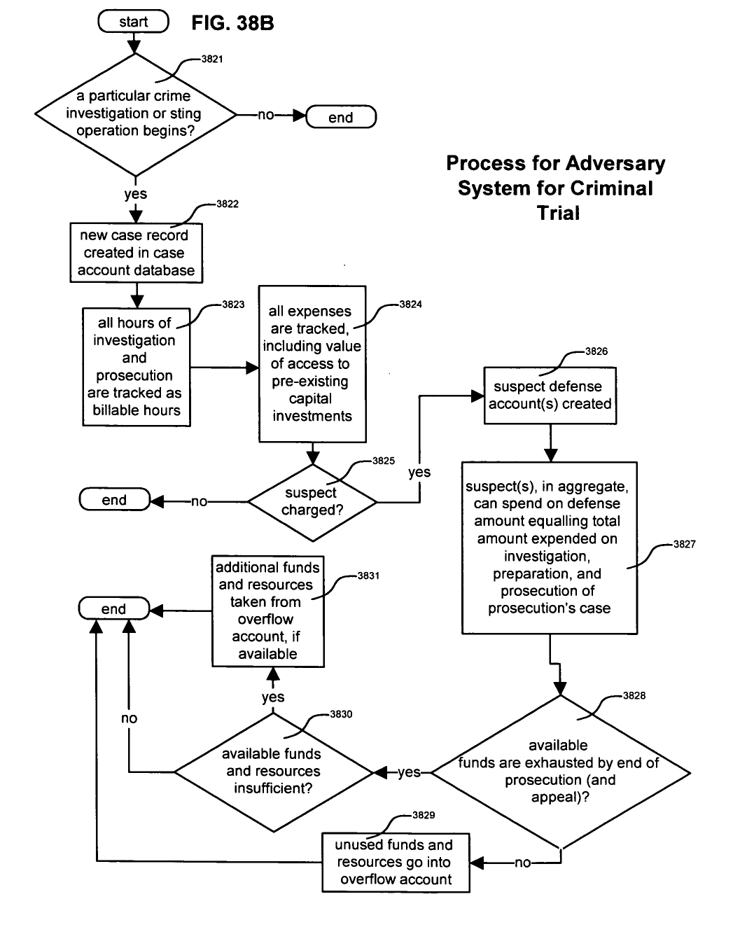

So as to enforce laws enacted under the present invention, a suspect-verifiable warrant process is disclosed in FIG. 38A. First, a city or state provides 3801 an arrest warrant database and establishes 3802 one or more mechanisms through which the public at large can access information contained in the arrest warrant database, preferably by telephone. The city or state then publicizes 3803 the availability and functionality of the arrest warrant database and the query mechanism for use therewith and imposes a duty on all law enforcement officers (e.g., Los Angeles Police Department) to comply with the remainder of the process.

Thereafter, when a warrant for search, seizure or arrest is issued 3804, a new record is created in the database and a unique serial number assigned 3805 to the warrant; the warrant must specifically identify the places, things and people to be searched or seized and must be supported by probable cause in the form of a sworn affidavit. When the warrant is executed, the officer or officers must notify 3806 the suspect of his or her right to verify the warrant under the current process. If no such notification is provided, the arrest is invalid 3807. If proper notice is provided, and the suspect chooses to verify the warrant, he or she calls a verification telephone number 3808, and an answering procedure previously established by the governing authority is followed. A suggested answering procedure is as follows: (i) a toll-free telephone number is printed on the face of a warrant and can be called by a party being arrested; (ii) the suspect's call is answered; (iii) the suspect enters (by speaking or keying in) the unique serial number appearing on the face of the warrant when prompted; (iv) the corresponding database record is retrieved; (v) and Information in the warrant—places, items, and people to be searched and seized—is read to the caller using text-to-speech software, prerecorded message, or live operator. If there be no valid warrant under that identification number, the caller is so notified.

If in fact the warrant is verified to be what it appears to be 3810, the arrest is valid 3811 and the suspect at least has this assurance. Meanwhile, if the warrant is fake or identifies someone other than the suspect, items or premises being subject to arrest, search or seizure, the action is invalid 3807, and the suspect learns this information through the phone call.

When a search, seizure or arrest occurs but no warrant is issued 3804, the action is invalid 3807 unless a warrantless search, seizure or arrest was permissible under the circumstances.

Optionally, the telephone number used can be a well-known public service number, such as “911”, thereby further assuaging any fears that a suspect may have regarding the authenticity of the warrant. Additionally, the suspect should be allowed to place the call using his or her own telephone, redoubling the credibility of the information gained.

Part VII: Process for an Adversary System of Trial Once an arrest has been made under the above disclosed processes, an adversary system for criminal prosecution that recognizes the state's compelling interest in preventing false imprisonment of its citizens—and particularly in preventing such tortious acts from being committed by the state itself—is disclosed in FIG. 38B.

When a law enforcement case is opened 3821, e.g., investigation of a crime already committed or arrangement of a sting operation begins, a new record is created 3822 in a case account database. Thereafter, all hours of time spent by detectives, law enforcement officials, and other state employees on the case are tracked 3823 as billable hours at market rates. All out-of-pocket expenses (materials, contractors' fees, etc.) are also tracked 3824, including the reasonable value of the actual usage of capital equipment (computers, communication equipment, etc.) that the state already owns.

Once a suspect is charged 3825, a new record is created 3826 in a suspect defense account database for the tracking of all costs incurred in the defense of the accused. The defendant or defendants are allowed 3827 funding for defense expenses in an amount that equals the total expended in investigating and prosecuting the case as shown in the record in the case account database. The state disburses funds as such costs are incurred. If the amount in the defendant's defense account record exceeds the amount in the case account record 3830, funds are drawn from an overflow account 3831, if available. If no overflow funds are available, the state need only provide funding for defense for the remainder of the trial that is sufficient to avoid constitutional or legal ethics challenges, i.e., the disclosed process ends and the defense is conducted thereafter as under the related art. If the trial ends while the case account record still exceeds the defense account record 3828, unused funds go into the overflow account 3829.

Part VIII: Universal Judicial Opinion Process

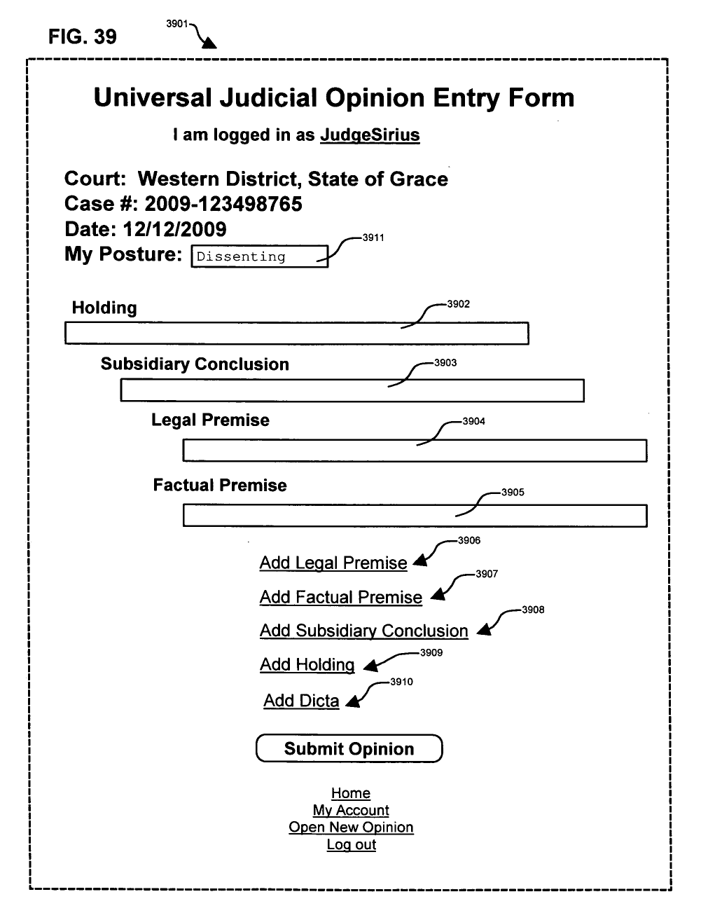

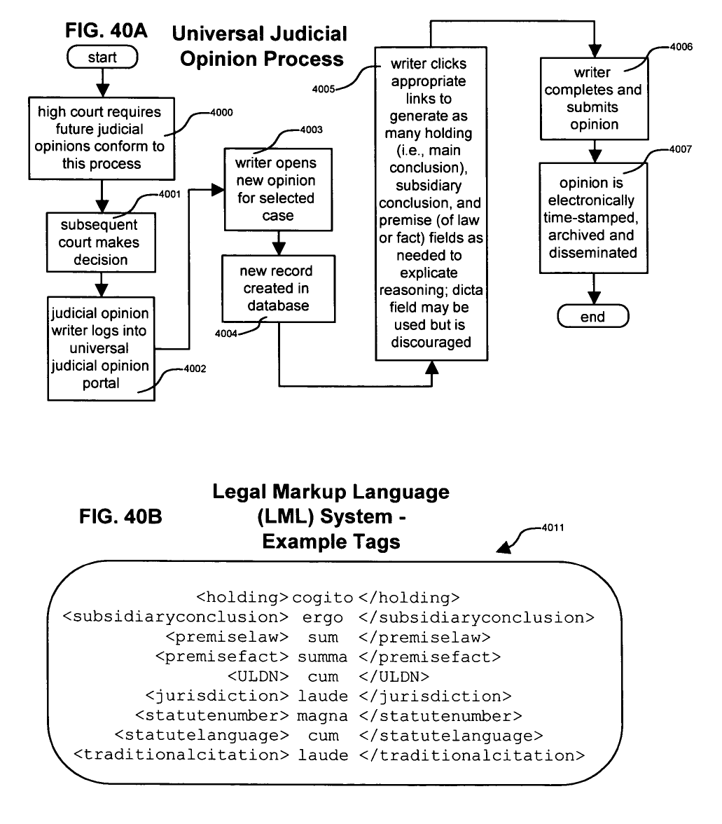

When a trial according to the above disclosed processes is conducted, a decision is reached and a judicial opinion written. Since, in a common law system, judicial opinions have the force of law, poorly written and poorly reasoned opinions serve to impede rather than promote the ends of a just society. So as to maximize the likelihood of judicial opinions being written at an acceptable level of quality, a universal judicial opinion submission form and Universal Judicial Opinion (UJO) process are disclosed in FIGS. 39 and 40A.

Depending upon governmental structure, the legislature or high court establishes 4000 a rule requiring that judicial opinions conform to the disclosed process. Thereafter, pursuant to this rule, a court makes a decision 4001 in a particular case, and a judge, whether writing as sole judge in the matter or as the selected writer for the majority (or concurring group or dissenting group) of a panel of judges, logs 4002 into a UJO site, a state-funded Internet-accessible electronic site, and indicates 4003 that he or she wishes to submit a new opinion for a specified case. A new record is then created 4004 in an opinion database, which record can be related to a record in a separate cases database so that all opinions pertaining to a single case or controversy remain related.

Once the opinion writer has entered information uniquely identifying the case for which the opinion is to be written, he or she navigates to the “Universal Judicial Opinion Entry Form” 3901 in FIG. 39. This form presents several data entry fields into which the writer can enter a holding 3902, a subsidiary conclusion 3903, a legal premise 3904 to be applied, and a factual premise 3905 that triggers application of a legal premise in the particular case at issue. Links are also provided which the writer can click 4005 so as to add as many additional data entry fields as necessary, including a link 3906 to add a legal premise field, a link 3907 to add a factual premise field, a link 3908 to add a subsidiary conclusion field, a link 3909 to add a holding field, and a link to add 3910 a dicta field (available, but use is discouraged). A pop-up menu 3911 is also provided through which the writer can indicate his or her orientation to the court's decision, e.g., writing for the majority, dissenting, or concurring in part. Using this form, the writer then crafts element by element an argument demonstrating the reasoning the court used in order to reach the decision it reached (if writing for the majority), how a different decision should have been reached (if dissenting), or how the same decision should have been reached by different reasoning (if concurring).

Once the judicial opinion is complete, the writer submits 4006 the opinion by clicking the “Submit Opinion” button. The opinion is then stored in the opinions database record, along with time-stamping information, and processed according to rules of the court.

So as to provide an easy mechanism for storing such texts that have the force of law and so as to maximize the accessibility of law to the citizens subject to it, a legal markup language (LML) is disclosed in FIG. 40B. Sentences and clauses of a judicial opinion, entered field by field as described above, or a statute are tagged with LML tags such as those depicted; opening and closing tags are shown for judicial opinions include a “holding” tag (<holding>), a “subsidiary conclusion” tag (<subsidiary conclusion>), a “legal premise” (<premise law>), and others; tags for codified law include those shown, such as a “statute number” tag (<statute number>) and a “statute language” tag. So as to facilitate transition from conventional methods of citing legal authority—whether those of private publishers or “vendor-neutral citations” —to the disclosed ULD method (below), a “traditional citation” tag (<traditional citation>) is also shown.

Part IX: Universal Legal Document (ULD) Process

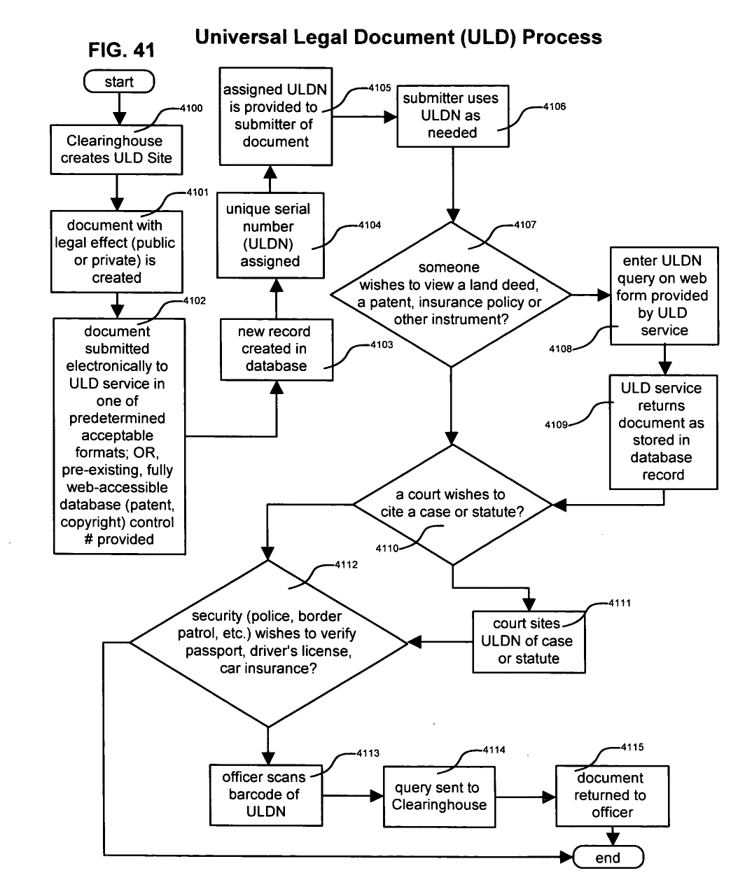

So as to maximize universal, free, intelligible access to law, a Universal Legal Document (ULD) process is disclosed in FIG. 41, which FIGURE includes essential steps of the basic process as well as some example steps for use in specific applications of the disclosed ULD system.

A ULD clearinghouse entity (“Clearinghouse”) is established, and it provides 4100 an Internet-accessible site (“ULD Site”) that includes database management software, documents and server software. Its primary functions are to store and serve documents and to assign unique numbers to such documents. When a document with legal effect, whether public (e.g., statute, case law) or private (e.g., contract), is created 4101, that document is submitted 4102 electronically to Clearinghouse through the ULD Site in a predetermined format (e.g., a plain text file or a LML file); optionally, in the case of certain documents that are already stored in a uniform, Internet-accessible database (e.g., patents) only the item-specific external identifier (e.g., patent number) may be submitted.

Upon receipt of the document, Clearinghouse creates 4103 a new record in a document database, stores a copy of the submitted document therein, and assigns 4104 a unique ULD number (ULDN) to the document. The ULDN is then provided 4105 electronically to the submitter of the document, who can then use 4106 the ULDN in any number of ways. Recommended ways include: the ULDN of each judicial opinion should appear after the case name when the opinion is published, and it should also be applied in barcode form on printed versions thereof; the ULDN of each statute should appear immediately after the statute number in publications of the code; the ULDN of official governmental identification papers (e.g., passport, driver's license) should be printed on the face of the document as well as encoded in a bar code that is also printed on the face of the document; similar uses of a ULDN should be made on the face of deeds, patents, contracts, and any other document with legal effect that is not intended to remain secret (e.g., certain private instruments).

The remainder of the flowchart in FIG. 41 depicts example steps for usage of the ULDN. For instance, if someone wishes to view 4107 a deed, he or she simply enters 4108 the ULDN in a search field on the ULDN Site, and Clearinghouse returns 4109 a copy of the document identified by the ULDN as stored in the database. If a judicial opinion writer either wishes to cite a case or statute 4110, he or she simply cites 4111 the ULDN thereof (in the case of a pinpoint citation to an opinion, a paragraph number can also follow the ULDN for use by a human looking up the citation, but the ULD system does not recognize this extra information, only whole documents). If a security or law enforcement officer wishes to verify the authenticity of a document or the identity of the holder of such a document, such as a driver's license, he or she scans 4113 a ULDN bar code appearing on the face of the document, sends 4114 the ULDN to Clearinghouse, and then Clearinghouse returns 4115 the requested document to the officer.

Part X: Implications and Scope

The present invention provides numerous benefits that are impossible or unavailable under the related art.

The disclosed jus voli system of citizenship determination provides greater flexibility and legitimacy in the relationship between citizens and governments. In so doing, it may be a significant weapon against jingoism and terrorism: it is much harder to dehumanize the people of a foreign state when some of a one's own friends have willingly joined that state as new citizens.

The disclosed sequential representation system of electing representatives provides a more fully democratic method of election and legislation. In so doing, the average value of each person's voice in government is enhanced, and the attractiveness of democracy as a form of government is increased.

The disclosed Uniform Political Platform System provides an unprecedented overturning of the power dynamics of political parties: instead of party agendas being dictated by an elite and wealthy few, party members themselves as a whole determine the policies and principles for which a party stands, and candidates become very strictly accountable for departures from the views of those whom they represent.

The disclosed Political Candidate Aptitude Test provides an opportunity for voters to make more informed choices than a sheer popularity contest allows, thereby augmenting the power of democracy to generate qualified leaders.

The disclosed adversary system affords citizens greater protection against false imprisonment. Additionally, the disclosed process gives rise to a significant tactical litigation incentive on the part of prosecutors to be frugal with state funds, since each dollar spent affords another dollar to the defense. Finally, the overflow account mechanism incentivizes investigators on a system wide level not to put resources into pursuing weak cases, since funds spent in building the state's case that are not expended in defense become accessible to future defendants.

Through the disclosed UJO process, when people are deprived of life, liberty or property, such grave action has been taken only after rigorous logic has been applied, documented, and made available for all to see, such that injustice can no longer count flawed reasoning among its allies. If, meanwhile, such a deprivation turns out to be based on logical fallacy, this fallacy will be made readily apparent by function of the present invention so that appropriate remedial measures—both on behalf of the parties involved in the immediate case and on behalf of the common law precedent system—can be taken.

Through the disclosed ULD process, the arcane and archaic landscape of legal research and citation—which, under the related art, requires mastery of a large number of disparate ways to cite and find different types of law in different jurisdictions—can be cleaned up so that a layperson can access legally effective documents from any jurisdiction easily using only a number and a computer.

Although the description above contains many specificities, these should not be construed as limiting the scope of the invention but as merely providing illustrations of some of the presently preferred embodiments of this invention. Accordingly, the scope of the invention should be determined by the appended claims and their legal equivalents, rather than by the examples given. For instance, as is plain to one skilled in the art, it will be understood that features of one embodiment may be combined with features of other embodiments while other features may be omitted or replaced as being nonessential to the practice of the invention, regardless of whether such combination, omission or modification has been explicitly described.

Licensing information may be obtained through http://www.inventerprise.com.

What is claimed is:

1. A method for building a platform for a first political party, said method comprising the following steps:
registering a first citizen and a second citizen;
creating a first database and a second database;
providing a first information submission mechanism, such as a first web submission form;
providing a second information submission mechanism, such as a second web submission form;
submitting a first statement through said first information submission mechanism, said first statement comprising language suitable for inclusion in said platform;
storing said first statement in said first database; and submitting a first position through said second information submission mechanism, said first position being selected from the group consisting of ratifying said first statement, opposing said first statement, or abstaining with respect to said first statement.

2. The method in claim 1 additionally comprising the following step: assigning a first numerical value to said first statement, wherein said first numerical value is at least partially determined by said first position.

3. The method in claim 2 additionally comprising the following step: comparing said first numerical value to a second numerical value, wherein said second numerical value is a predetermined threshold.

4. The method in claim 3 additionally comprising the following step: adopting said first statement as part of said platform when said first numerical value meets or exceeds said second numerical value.

5. The method in claim 4 additionally comprising the following step: donating funds to said political party, said funds being earmarked for use in connection with said first statement.

6. The method in claim 5 additionally comprising the following step: submitting a report pertaining to how said funds have been used.

7. The method in claim 1 additionally comprising the following step: displaying said first statement in a first document, wherein said first document further comprises said second information submission mechanism.

8. The method in claim 7 additionally comprising the following step: adopting or rejecting said statement as part of said platform as a result of said submitting a first position.

9. The method in claim 7 wherein said first document further comprises a first indicator, said first indicator being selected from the group consisting of a strength indicator, a weight indicator, a status indicator, or a breakdown indicator.

10. The method in claim 9 wherein:
said strength indicator is determined at least partially by how unanimous members of said party are with respect to said first statement;
said weight indicator is determined at least partially by how many members of said political party have taken a position on said first statement;
said status indicator is determined by whether said first statement has been adopted as part of said platform; and
said breakdown indicator is a quantity or percentage of members of said political party who have taken a particular position with respect to said first statement.

11. The method in claim 1 additionally comprising the following step: assigning a value to a first candidate, wherein said value results from comparing said first position to said platform.

12. The method in claim 1 wherein said step of submitting a first position is performed by said first citizen and said step further comprises the step of automatically committing said second citizen to said first position.

13. A method of creating a political party platform, said method comprising the following steps:
submitting a first statement, said first statement comprising language suggested for inclusion in said platform and said step of submitting a first statement being performed by a first user;
storing said first statement in a first record, said first record being a record in a first database;
submitting a first position with respect to said first statement, said step of submitting a first position being performed by a second user and said first position being selected from the group consisting of ratifying said first statement, opposing said first statement, and abstaining with respect to said first statement;
storing said first position in a second record, said second record being a record in a second database;
relating said first record to said second record; and
assigning a first value to said first statement, wherein said first position affects said first value.

14. The method in claim 13 additionally comprising the following step: submitting a first donation, said donation being earmarked for purposes related to said first statement.

15. The method in claim 13 additionally comprising the following steps: comparing said first value to a predetermined threshold value; and adopting or rejecting said first statement as a result of said comparing.

16. A method of displaying elements of a political party platform, said method comprising the following step:
accessing information stored on a first server so as to retrieve a first document, wherein said first document comprises language pertaining to a particular issue and further comprises at least one of the following:
(i) a dynamically generated status indicator that indicates whether said language is currently part of said political party platform;
(ii) a ratifications indicator that indicates how many people have ratified said language;
(iii) an oppositions indicator that indicates how many people have opposed said language; or
(iv) a current position indicator that indicates what position a first user has taken with respect to said language.

17. The method in claim 16 wherein said ratifications indicator is a sum.

18. The method in claim 16 wherein said ratifications indicator is a percentage.

19. The method in claim 16 additionally comprising the following step: displaying a first field, said first field being suitable for entry of a quantity of funds, said funds being earmarked for use in connection with said language.

20. The method in claim 13 additionally comprising the following step: assigning a second value according to whether a political candidate agrees with said first statement.
